(19) United States
(12) Patent Application Publication
(10) Pub. No.: US 2002/0184083 A1
(43) Pub. Date: Dec. 5, 2002

(54) Quality function development support method and storage medium

(76) Inventors: Takashi Nakano, Yokohama-shi (JP); Kunio Noguchi, Yamato-shi (JP); Yuji Kyoya, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/157,154

(22) Filed: May 30, 2002

(30) Foreign Application Priority Data
May 31, 2001 (JP) 2001-164692

(51) Int. Cl. G06F 17/60

(52) U.S. Cl. 705/10

(57) ABSTRACT

A method of supporting creation of a quality function development chart which converts customer requirements to product characteristics urges input of customer requirements, urges input of product characteristics associated with the customer requirements, urges input of a degree of association of the customer requirements and the product characteristics, and urges input of a design quality for each of the product characteristics.

### CROSS-REFERENCE TO RELATED APPLICATIONS

This application is based upon and claims the benefit of priority from the prior Japanese Patent Application No. 2001-164692, filed May 31, 2001, the entire contents of which are incorporated herein by reference.

### BACKGROUND OF THE INVENTION

1. Field of the Invention

The present invention relates to a method for supporting a quality function development technique to be applied to strategic planning of a product, calculation of quality importance rating of a product, and design support and a recording medium storing a quality function development supporting program.

2. Description of the Related Art

As a method of determining product specifications from the aspect of product characteristics while planning or developing a product, quality function development (reference “Quality Development Method (1)”, Nikkagiren Shuppan-Sha) is known. Quality function development is also called QFD. This is a method of grasping and analyzing customer requirements for a product and converting the customer requirements into product characteristics and also into parts characteristics. This QFD is realized by a system using a computer and applied for product planning, calculation of a product quality importance rating, and design support.

In product planning and the like using QFD, operations such as converting a goal with respect to customer requirements into a numerical value, extracting and linking product characteristics related to the customer requirements, and converting the product characteristics into a numerical value are done by QFD executers (persons who are engaging in product planning and the like) using a QFD chart.

Conventionally, the work, in which the QFD operator obtains electronic QFD data by carrying out inputting items such as numeric values or the like on the QFD chart, requires skills to some extent, and there are problems that errors and loss in inputting occur frequently and the work load has to be borne. Defects in QFD work at an initial stage of product planning or the like, such as considering the requirement from a customer, may have a large influence on sales of the product actually introduced into the market or the like. Here, it is essential that workability is improved so as to be able to prevent such defects in advance.

### BRIEF SUMMARY OF THE INVENTION

Accordingly, the present invention is directed to a method and a recording medium storing a program for supporting such that a QFD operator can carry out QFD work appropriately and easily.

According to an embodiment of the present invention, a method of supporting creation of a quality function development chart which converts customer requirements to product characteristics, comprises urging input of the customer requirements, urging input of product characteristics associated with the customer requirements, urging input of a degree of association between the customer requirements and the product characteristics, urging input of a satisfaction degree of the customer requirements, urging input of a comparison value to be compared with the satisfaction degree of the customer requirements, and urging input of a design quality which is a goal of the customer requirements.

According to an embodiment of the present invention, an article of manufacture comprising a computer usable medium having computer readable program code means of supporting creation of a quality function development chart which converts customer requirements to product characteristics embodied therein, the computer readable program code means comprises computer readable program code means for causing a computer to urge input of the customer requirements, computer readable program code means for causing a computer to urge input of product characteristics associated with the customer requirements, computer readable program code means for causing a computer to urge input of a degree of association between the customer requirements and the product characteristics, computer readable program code means for causing a computer to urge input of a satisfaction degree of the customer requirements, computer readable program code means for causing a computer to urge input of a comparison value to be compared with the satisfaction degree of the customer requirements, and computer readable program code means for causing a computer to urge input of a design quality which is a goal of the customer requirements.

### BRIEF DESCRIPTION OF THE SEVERAL VIEWS OF THE DRAWING

FIG. 1 is a block diagram showing a hardware constitution of a QFD support system according to a first embodiment of the present invention;

FIGS. 2A, 2B, 2C, and 2D are a chart showing one example of a QFD chart to be applied to the system of the first embodiment, and FIG. 2E shows the manner in which FIGS. 2A, 2B, 2C, and 2D are combined;

FIG. 3 is a flowchart showing a basic procedure of QFD in the system of the first embodiment;

FIG. 4 is a table showing a schematic procedure of QFD support according to the system of the first embodiment;

FIGS. 5A, 5B, 5C, and 5D are a chart showing a concrete example of QFD, and FIG. 5E shows the manner in which FIGS. 5A, 5B, 5C, and 5D are combined;

FIG. 6 is a diagram showing a constitution of VoC data;

FIG. 7 is a flowchart showing a procedure of inputting support of the QFD chart according to the system of the first embodiment;

FIG. 8 is a flowchart showing a procedure of “setting support of a goal” according to the system of the first embodiment;

FIG. 9 is a chart showing one portion of the QFD chart of FIGS. 5A to 5D;

FIG. 10 is a scatter diagram displayed by a displaying device of the system of the first embodiment;

FIG. 11 is a flowchart showing a procedure of “automatically associating at the time of extracting product characteristics” according to the system of the first embodiment;

FIG. 12 is a chart showing another portion of the QFD chart of FIGS. 5A to 5D;

FIG. 13 is a flowchart showing a procedure of “displaying the resetting of product characteristics when a direction of improvement is erroneously set” according to the system of the first embodiment;

FIG. 14 is a table for explaining screen changes on a QFD chart at the time of displaying the resetting of product characteristics;

FIG. 15 is a table for explaining screen changes on a QFD chart at the time of displaying the resetting of product characteristics following FIG. 14;

FIG. 16 is a flowchart showing a procedure of checking a quality chart according to the system of the first embodiment;

FIG. 17 is a table showing examples of violations of rules to be used in checking the quality chart;

FIG. 18 is a flowchart showing a procedure of validity evaluation of the quality chart by calculating an importance rating according to the system of the first embodiment;

FIG. 19 is a table showing importance ratings of customer requirements calculated by an independent weighting method and a proportional weighting method in the system of the first embodiment, and absolute values of the differences between these importance ratings (evaluation index of the quality chart);

FIG. 20 is a flowchart showing a procedure of checking a satisfaction degree of the customer requirements, the product characteristics (benchmark value), and an association between the degree of satisfaction and the product characteristics according to the system of the first embodiment;

FIG. 21 is a table showing trends and characteristics of four patterns of relationship between the product characteristics and the degree of satisfaction of the customer requirements;

FIGS. 22A, 22B, 22C, and 22D are a chart showing still another portion of the QFD chart of FIGS. 5A to 5D, and FIG. 22E shows the manner in which FIGS. 22A, 22B, 22C, and 22D are combined;

FIG. 23 is a flowchart showing a procedure of checking the design quality based on the degree of satisfaction of the customer requirement and the benchmark value according to the system of the first embodiment;

FIGS. 24A, 24B, 24C, and 24D are a chart showing still further portion of the QFD chart of FIGS. 5A to 5D, and FIG. 24E shows the manner in which FIGS. 24A, 24B, 24C, and 24D are combined;

FIG. 25 is a flowchart showing a procedure of displaying a guideline of a design quality according to the system of the first embodiment;

FIGS. 26A, 26B, 26C, and 26D are a chart showing still another portion of the QFD chart of FIGS. 5A to 5D, and FIG. 26E shows the manner in which FIGS. 26A, 26B, 26C, and 26D are combined; and

FIGS. 27A, 27B, and 27C are a chart showing a QFD (QFD-II) chart according to a second embodiment of the present invention, and FIG. 27D shows the manner in which FIGS. 27A, 27B, and 27C are combined.

### DETAILED DESCRIPTION OF THE INVENTION

A QFD support method and storage medium according to an embodiment of the present invention will be described below with reference to the accompanying drawing.

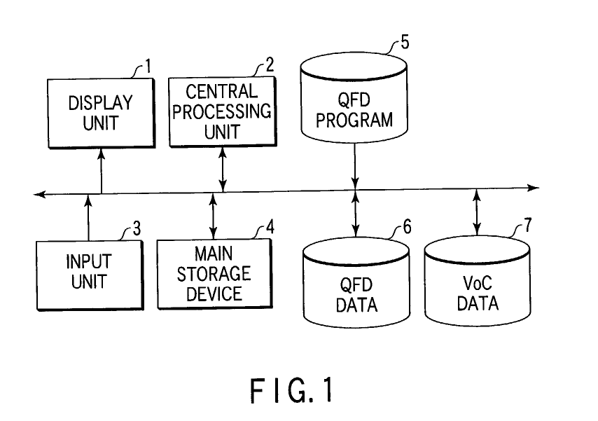

FIG. 1 is a block diagram showing the hardware configuration of a computer system that realizes the QFD support method according to the first embodiment of the present invention. This system has a display unit 1, central processing unit (CPU) 2, input unit 3, and main storage unit 4. A QFD program 5 shown in FIG. 1 creates and edits data (spreadsheet data) 6 of a QFD chart, which is applied to product planning, calculation of importance of product characteristics, and design support, and realizes various kinds of information processing of generating customer satisfaction evaluation information. This program is loaded to the main storage unit 4 and executed by the central processing unit 2. When the program 5 is executed, a QFD chart is displayed on the display unit 1, an item (also called a cell) on the chart is selected through the input unit 3 such as a keyboard or mouse, and characters or numerical values are input under the control of the central processing unit 2. The system of this embodiment also has a function of referring to VoC (Voice of Customer) data 7 at the time of QFD operation. The data structure and reference of the VoC data 7 will be described later.

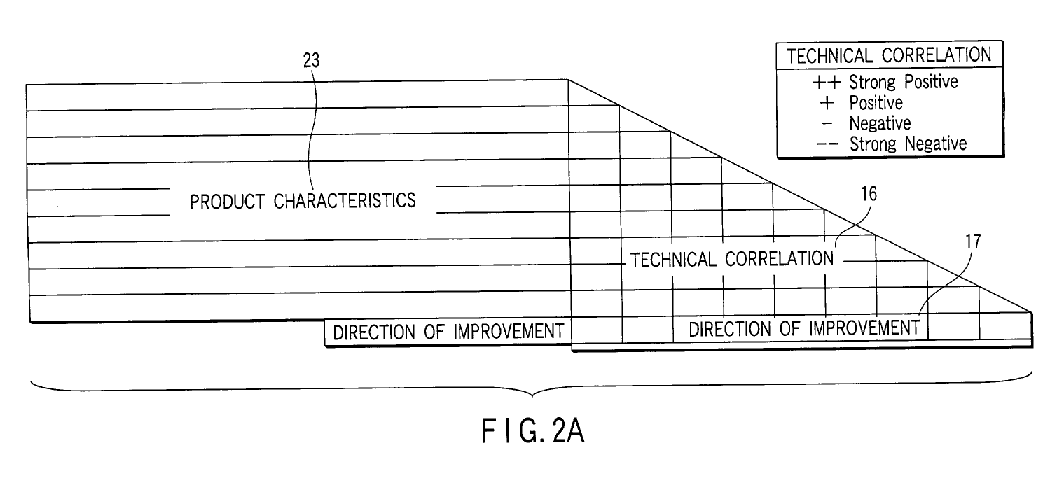

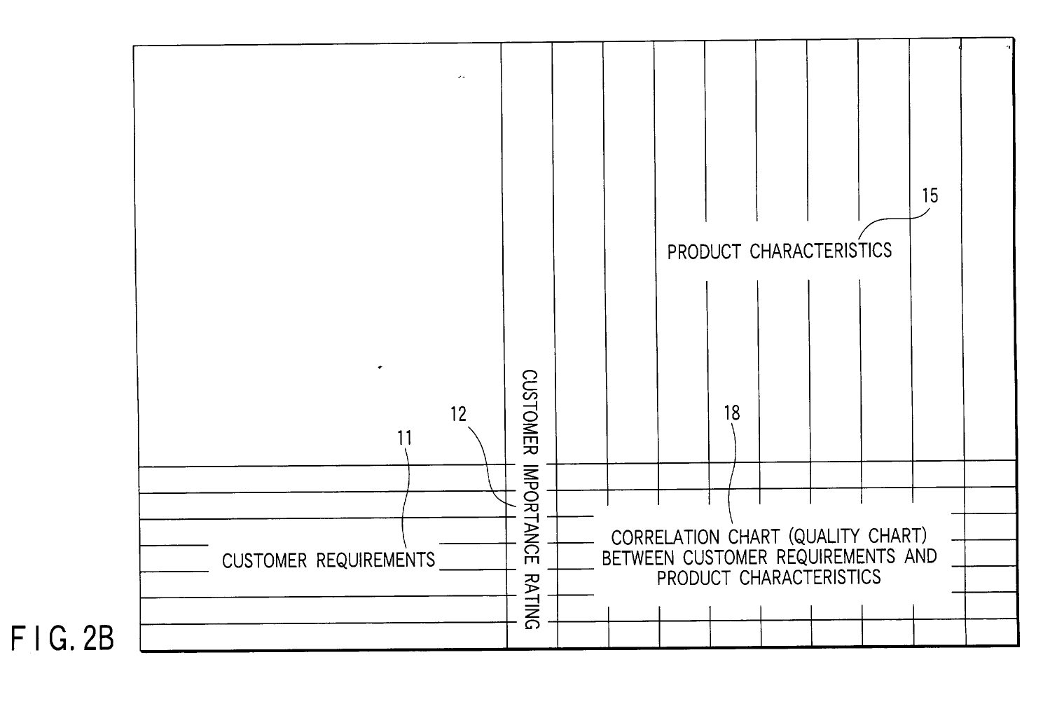

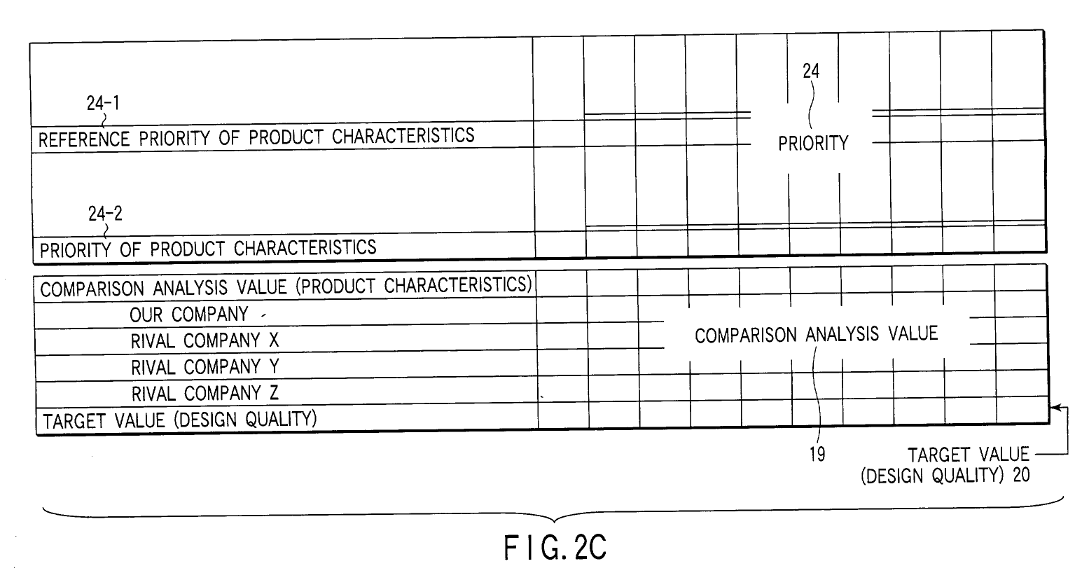

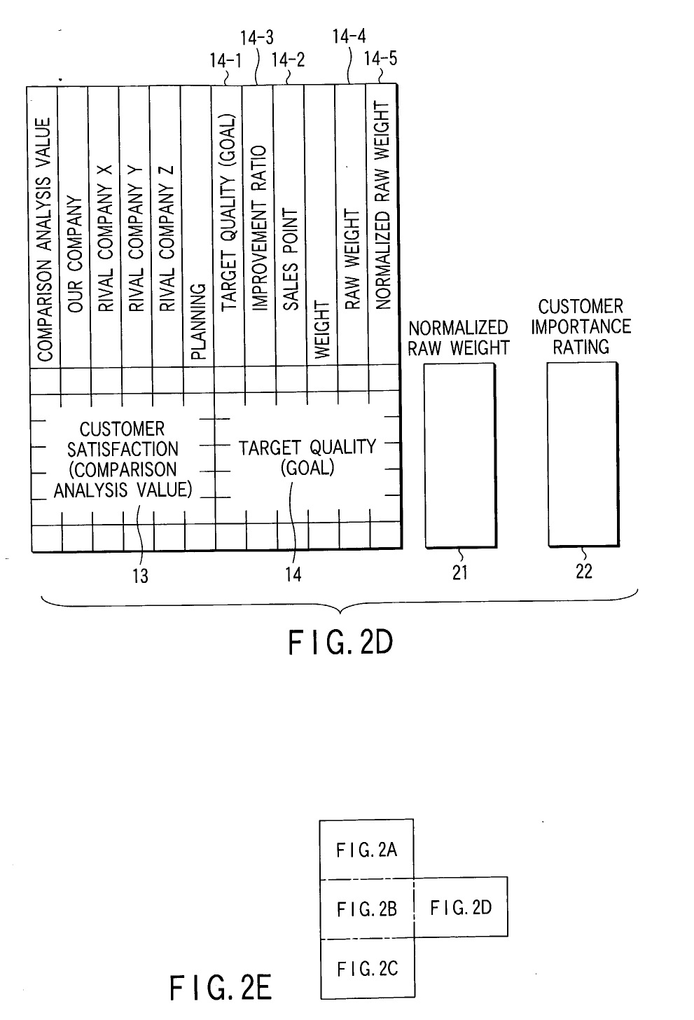

FIGS. 2A to 2D are a view showing a QFD chart applied to the system of the present invention. This QFD chart is created from electronic spreadsheet data and used as the template of the QFD data 6. As shown in FIGS. 2A to 2D, the QFD chart is created from a plurality of table items and, more specifically, customer requirements 11, customer importance rating 12, customer satisfaction (also called comparison analysis value) 13, target quality (goal) 14, normalized raw weight 21, customer importance rating 22, product characteristics 15 and 23, technical correlation 16, direction of improvement 17, customer requirements vs. product characteristics correlation chart (quality chart) 18, priority 24, comparison analysis value (benchmark value) 19 of the product characteristics, and target (design quality) 20. Obtaining the priorities 24 of each item of the product characteristics from the customer importance rating 12 of each item of the customer requirements 11 is called “development”.

Using such a QFD chart, items of the customer requirements 11 from the customer are listed in the row direction (vertical direction) of the QFD chart, and items of the functions are developed in the column direction (horizontal direction: product characteristics) of the chart. This QFD will be referred to as QFD-I here. Operations of grasping and analyzing customer requirements from a customer for a product or service and converting the customer requirements into the product characteristics are done in this QFD-I.

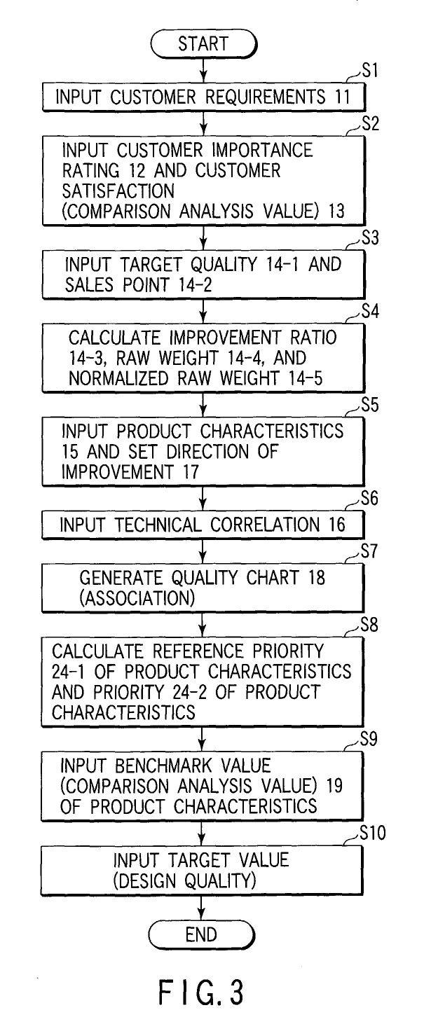

FIG. 3 is a flow chart showing the basic procedure of QFD-I. A QFD executer inputs or edits data on the QFD chart shown in FIGS. 2A to 2D in accordance with the basic procedure shown in FIG. 3. The basic procedure of QFD-I is formed from inputting the customer requirements 11 (step S1), inputting the customer importance rating 12 and the customer satisfaction (comparison analysis value) 13 (step S2), inputting the target quality 14 (step S3) (inputting the target quality includes inputting a target quality 14-1 in the narrow sense and also inputting a sales point 14-2), calculating an improvement ratio 14-3, raw weight 14-4, and normalized raw weight 14-5 (step S4), inputting the product characteristics 15 and setting the direction of improvement 17 (step S5), inputting the technical correlation 16 (step S6), associating the customer requirements with product characteristics (creating the quality chart 18) (step S7), calculating the priority 24 (a reference priority 24-1 of product characteristics and priority 24-2 of product characteristics) (step S8), inputting the comparison analysis value (benchmark value) 19 of product characteristics (step S9), and determining (inputting) the target value (design quality) 20 (step S10). In calculation steps S4 and S8, when necessary data is given, the computer system of this embodiment automatically calculates the values and fills the QFD chart with them. Steps S9 and S10 may be omitted. If the reference priority 24-1 of product characteristics and priority 24-2 of product characteristics seem to be inappropriate, the flow returns to step S5 or S7 to add or delete product characteristics or re-inputting the technical correlation.

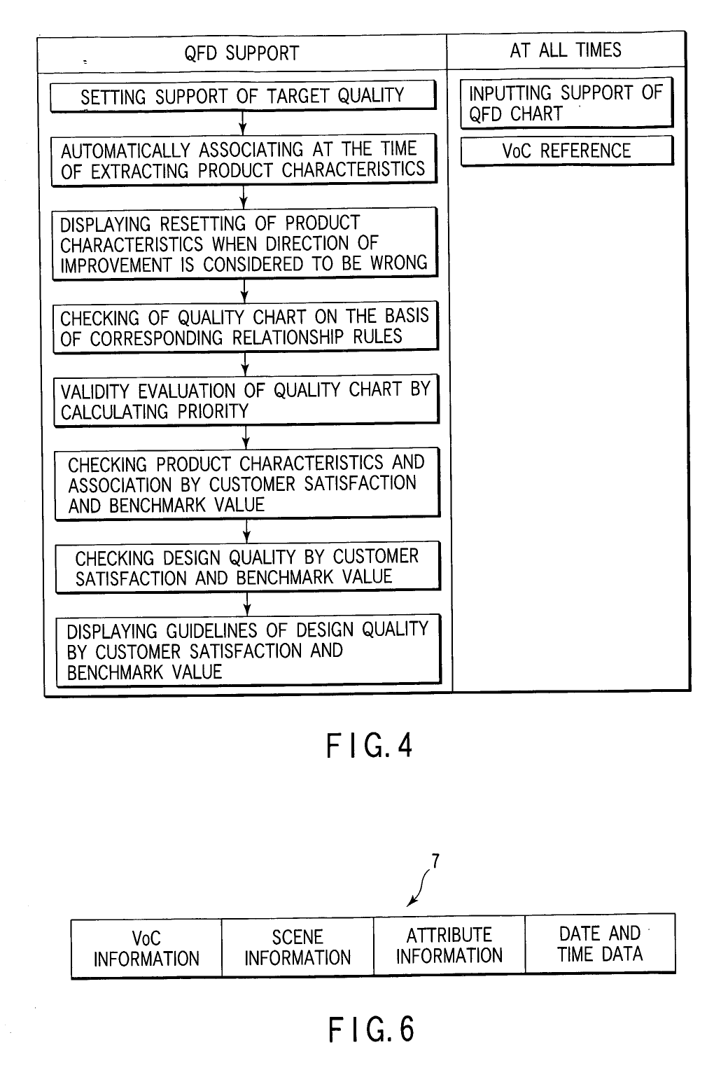

FIG. 4 shows a table explaining a schematic procedure of QFD support in which the QFD-I can be executed in an appropriate and easy way. Each step of the QFD support procedure is related to each step of the basic procedure of FIG. 3 and is realized by the QFD program executed by the computer system of the embodiment. As shown in the right column of FIG. 4, inputting support of QFD chart and VoC reference can be executed at all times.

The basic procedure of QFD-I and the QFD support will be described below based on a detailed example.

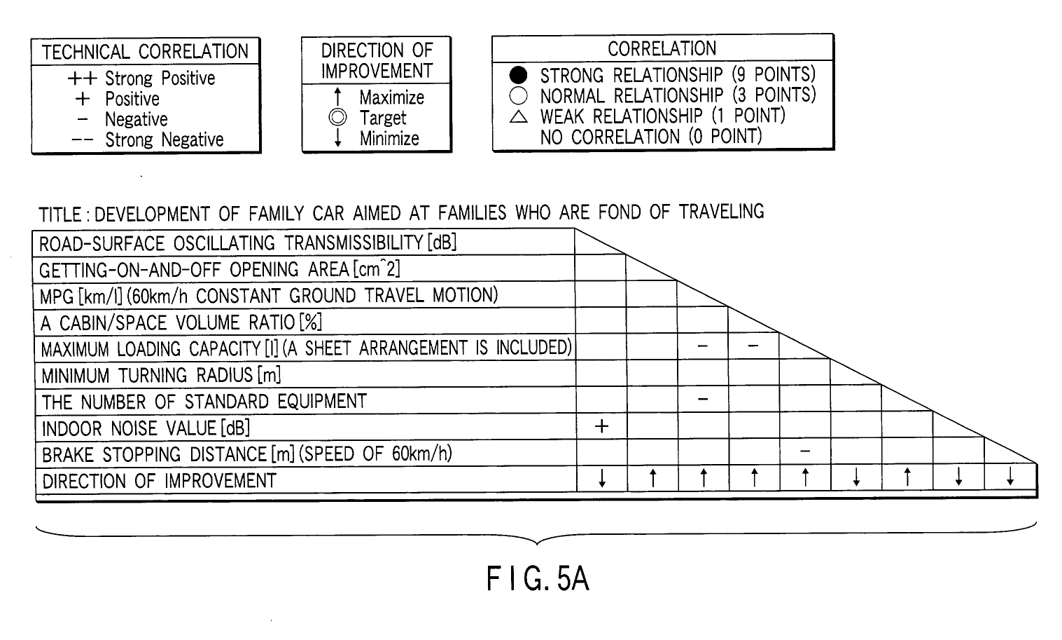

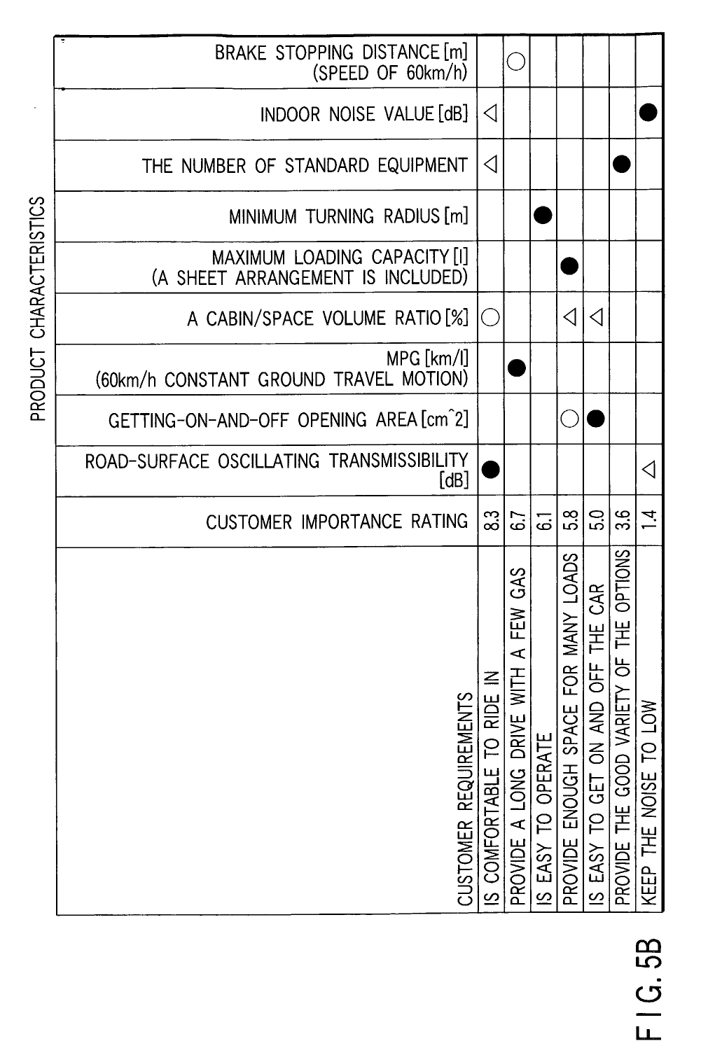

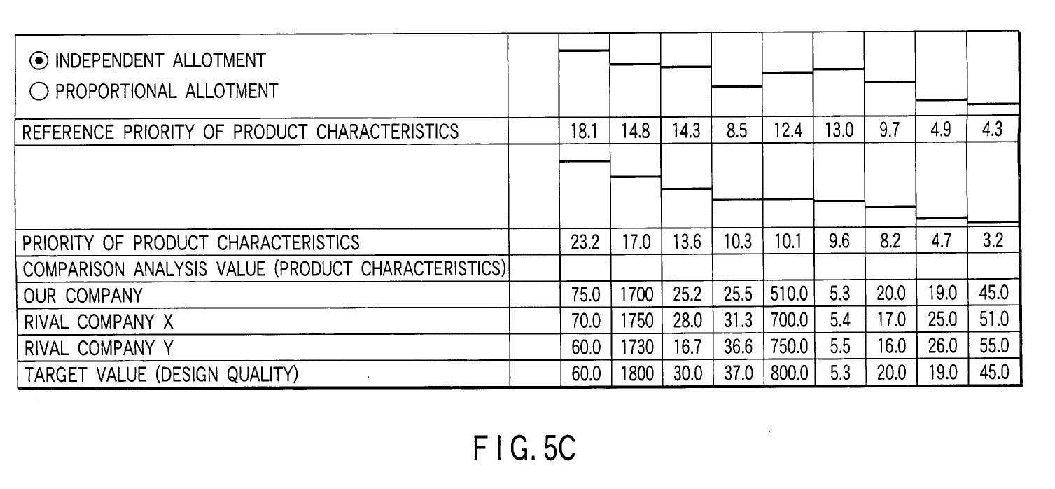

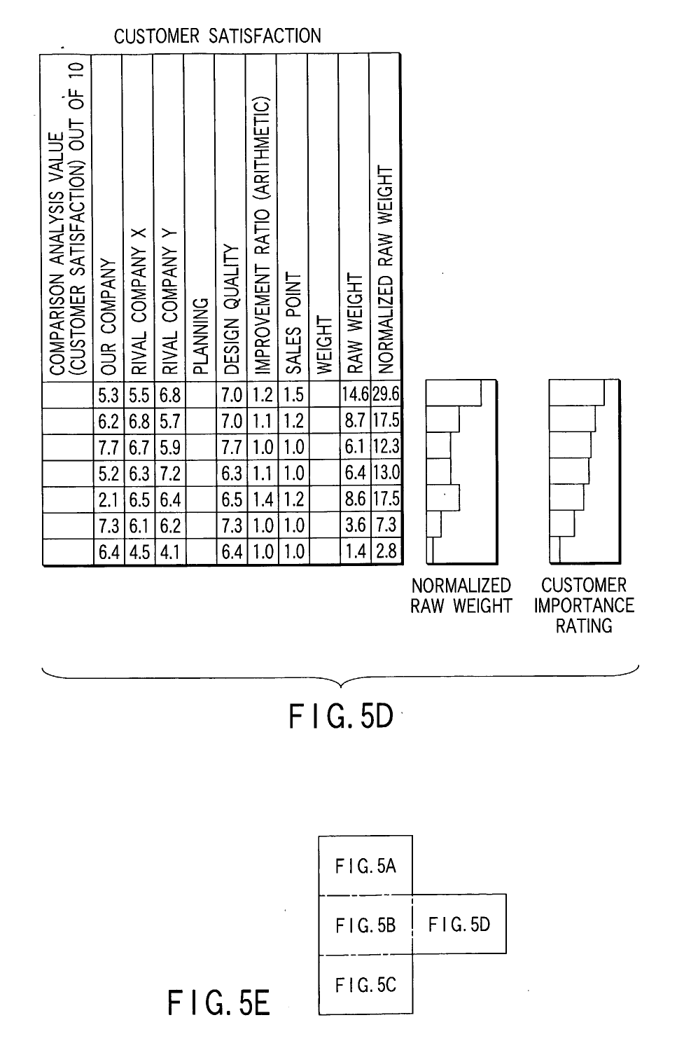

FIGS. 5A to 5D show QFD-I in “merchandize planning of family car aimed at families who are fond of traveling”. In this QFD-I, first, the QFD executer is caused to input requirement items to the field of the customer requirements 11. In this case, e.g., items “Is comfortable to ride in”, “Provide enough space for many loads”, “Is easy to operate”, and the like are input based on customer's requests (step S1 in FIG. 3). Instead of manually inputting the requirement items by the QFD executer, they may be automatically extracted and input based on VoC (Voice of Customer) data 7 (to be described later).

Next, for each of the customer importance ratings, a relative value of the rating to the maximum value “10” is input to the field of customer importance rating 12 on the QFD chart based on a questionnaire result obtained in advance. Here, customer importance rating “8.3” is input for, e.g., customer requirement “Is comfortable to ride in”. In a similar manner, customer importance rating “6.7” is input for, e.g., customer requirement “Provide enough space for many loads”. In addition, for each of the customer requirements 11, customer importance rating is input to the field of customer satisfaction 13. In this case, the degree of customer satisfaction is input as 10-grade evaluation value according to questionnaire results obtained in advance about our company and other companies (e.g., rival companies X, Y, and Z) at the current time (step S2).

Next, the QFD executer is caused to set and input the target of the degree of customer satisfaction for the next coming planned product (here, a family car) to the field of target quality 14-1 in the narrow sense as 10-grade evaluation value. In addition, the QFD executer is caused to select the degree of appeal of the new product or service (sales point) 14-2 from three values, e.g., 1.0 (current level should be maintained), 1.2 (certain sales point), and 1.5 (important sales point) and input the value (step S3).

When the customer satisfaction 13 and sales point 14-2 are input, the improvement ratio 14-3 representing the degree of necessary improvement of the target quality with respect to the current satisfaction is automatically calculated. This improvement ratio is calculated by, e.g.,

Improvement ratio=1+0.1×(target quality−customer satisfaction for our company)

Referring to FIGS. 5A to 5D for, e.g., the item “Is comfortable to ride in” in the customer requirements 11, the customer satisfaction 13 for our company is 5.3, and the target quality 14 is 7.0. As the value of the improvement ratio 14-3 calculated in accordance with the above formula, 1.17 is rounded to 1.2. In addition, the raw weight 14-4, i.e., an evaluation value calculated from the product of the customer importance rating 12, improvement ratio 14-3, and sales point 14-2 is automatically calculated. For, e.g., the customer requirement “Is comfortable to ride in”, the customer importance rating 12 is 8.333 . . . (=8.3), the improvement ratio 14-3 is 1.17 (=1.2), and the sales point 14-2 is 1.5. Hence, a value “14.6” is obtained as the raw weight 14-4 by calculation. Furthermore, as a percentage in the total raw weight (100%), a weight coefficient “29.6” of the raw weight 14-4 of the customer requirements is automatically calculated as the normalized raw weight 14-5 (step S4).

Next, operation of converting the customer requirements 11 into the product characteristics 15 as a technical matter of the product is performed. First, the QFD executer is caused to extract the product characteristics, which are necessary for acquiring the customer satisfaction 13 (comparison analysis value) of the customer requirements 11, and input them to the fields of product characteristics 15. In addition, the QFD executer is caused to set and input the direction of increase/decrease in the improvement of each of product characteristics to the field of the direction of improvement 17 (step S5). As the direction of improvement 17, the QFD executer is caused to set and input one of a direction in which the product characteristics is maximized, a direction in which the product characteristics is minimized, and a direction in which the product characteristics is made close to a specific target. As shown in FIGS. 5A to 5D, these directions of improvement are indicated by, e.g., an up arrow (↑), down arrow (⇓), and double circle (⊚) on the QFD chart.

The plurality of extracted product characteristics have such correlations that when the performance of one product characteristics is improved, that of another product characteristics degrades (strong negative), or as the performance of one product characteristics is improved, that of another product characteristics is also improved (strong positive). Such correlations are input to the field of the technical correlation 16 on the QFD chart (step S6). As shown in FIGS. 5A to 5D, these correlations are indicated by, e.g., “−−”, “−”, “+”, and “++” on the QFD chart.

Next, the QFD executer is caused to associate the customer requirements 11 with the product characteristics 15 to create the quality chart 18 and select each degree of association from predetermined points (step S7). For example, a high degree of association is marked with [ (association level is 9), a normal degree of association is marked with ◯ (association level is 3), and a low degree of association is marked with Δ (association level is 1) These degrees of association are indicated on the QFD chart 18. According to FIGS. 5A to 5D, for example, a customer requirement “Is comfortable to ride in” is most associated with product characteristics “Road-surface oscillating transmissibility [dB]”, for which the highest degree of association (●: association level is 9) is set by the QFD executer. This customer requirement is also associated with a product characteristic “A cabin/space volume ratio [%]” as a normal degree of association (◯: association level is 3).

The reference priority 24-1 of product characteristics and priority 24-2 of product characteristics are automatically calculated from the quality chart 18 formed by associating, the customer importance rating 12, and the normalized raw weight value, 21 (step S8). The reference priority 24-1 of product characteristics can be obtained by, e.g.,

Reference priority of product characteristics=Σ{customer requirement×association level between product characteristics and customer importance rating} (1)

wherein Σ is the sum of all customer requirements for each of the product characteristics. Note that the reference priority of product characteristics is represented by a percentage with respect to all the product characteristics.

The priority 24-2 of product characteristics is obtained by replacing the customer importance rating 12 in equation (1) with the normalized raw weight 14-5.

Each of the reference priorities 24-1 of product characteristics can be regarded as a value calculated based on the customer importance, and each of the priorities 24-2 of product characteristics can be regarded as a value obtained in consideration of the product strategy (product planning policy) of our company as well as the customer importance. With this calculation, the reference priority 24-1 of product characteristics of “Road-surface oscillating transmissibility [dB]” is calculated as 18.1.

Next, the QFD executer is caused to input the comparison analysis value 19 of product characteristics.

The comparison analysis value 19 is the actually measured value of the product characteristics of the products of our company and other companies. The products can also be benchmarked using the values (step S9). Finally, the QFD executer is caused to input the target value (design quality) of each of the product characteristics of the product to be newly developed to the field of target value 20. These values are the target specifications of the final product (step S10).

Here, a procedure of the QFD support, for enabling the QFD operator to carry out the work of the QFD-I as described above appropriately and easily such that inputting errors or inputting losses of respective items do not arise, will be described.

1. VoC Reference (at all Times)

VoC is information from a customer obtained by carrying out, for example, a group interview or the like. The VoC data 7 which is electronic data of such information is, for example, as shown in FIG. 6, comprises VoC information, scene information, attribute information, date and time information of data creation, and the like. The VoC information comprises data showing contents (text) of the voice of customer. Further, the scene information is data showing under what situation the customer voiced his/her opinion, what contents the question had, and the like. The attribute information is data showing the name, age, sex, occupation, and family make-up, and the like, of the customer.

In the QFD support of the present embodiment, the system of the present embodiment refers to the VoC data 7 at all times and displays it on the displaying device 1. The reference display becomes a support by which the QFD operator can extract the appropriate customer requirements on the QFD chart.

When extraction of customer requirements is carried out based on the VoC data 7, link information to the VoC data 7 that represents the source of extraction is given to the data item of the customer requirements of the QFD data 6, and recorded. In this way, due to the association of the customer requirements and the VoC data being stored as link information, the QFD operator can always quickly trace from the customer requirements to the corresponding VoC data 7 while in the midst of QFD work, and workability of extracting the customer requirements can be improved. Note that, in such linking of the QFD and the VoC, there is not only the extracting of the customer requirements, but also other advantages. For example, there is reference (which will be described later) to the VoC information for evaluating the design quality (goal) or the like.

2. Inputting Support of QFD Chart (at all Times)

When the customer requirements are extracted, creation of the QFD chart proceeds in accordance with the basic procedure described above, such as the importance rating and the degree of satisfaction of the customer requirements are inputted based on the results of a questionnaire for customers or the like. At this time, by clearly displaying information such as where and by what processes which data in the QFD chart should be inputted, and what type of study and consideration should be given in the input of data, and the like, guidance (navigation) is carried out such that the QFD operator can smoothly carry out the input work to the QFD chart.

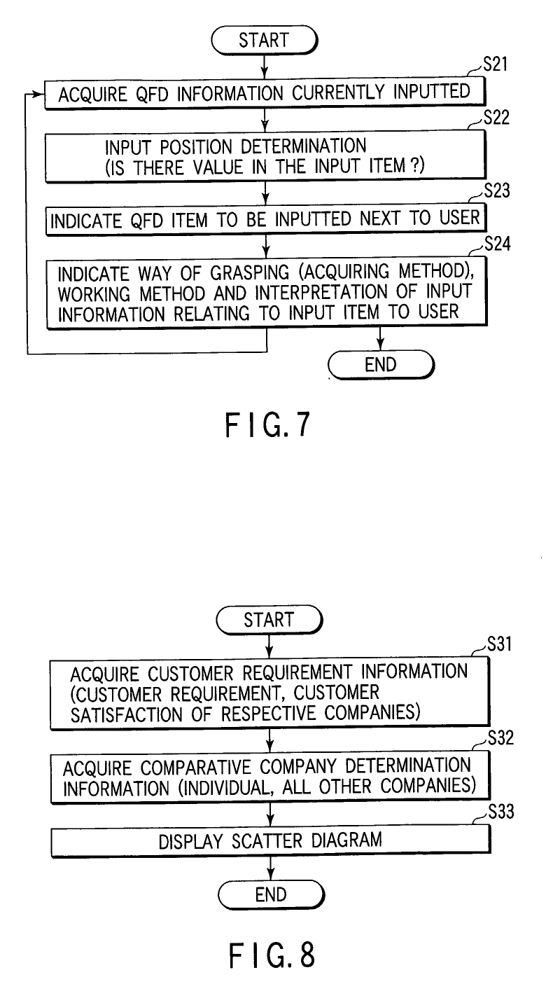

FIG. 7 is a flowchart showing a procedure of inputting support of the QFD chart. The procedure comprises step S21 of acquiring QFD input information inputted up to the current time, step S22 of determining un-inputted points (QFD items at which values have been not inputted at the input items), step S23 of displaying to the QFD operator the QFD items which should be next inputted, and step S24 of appropriately reading and displaying, from the previously stored information, the way of grasping (acquiring method), working method, interpretation, and the like of the input information relating to the input items.

The object items on the QFD chart for which determination is carried out as to whether or not the item is un-inputted in step S22 are, in order, the customer requirements 11, customer importance rating 12, customer satisfaction (comparison analysis value) 13, target quality (goal) 14-1, sales point 14-2, product characteristics 15, direction of improvement 17 of the product characteristics, technical correction 16 of the product characteristics, quality chart 18, comparison analysis value 19 of the product characteristics, and target value (design quality) 20. The order of data input is basically this order (refer to FIG. 3). Displays/instructions, urging the QFD operator to carry out input with respect to the QFD items for which data are not inputted yet, are successively carried out.

Further, immediately after the item input of, for example, the customer requirements 11 is completed, a display such as “Please have the QFD operator determine customer importance rating. It is effective to carry out a method such as pared comparison or the like at this time.” or the like is carried out, and an input field at which the customer importance rating 12 is to be inputted is indicated to the QFD operator. For all of the processes of the QFD which will be described hereinafter, such instructions appropriately indicate, based on the determination as to whether or not a value has been inputted into the input field, to the QFD operator the place of the input field, the working method, key points, and the like.

The above-described two supports are carried out at all times, and the following eight supports are carried out in order in accordance with the procedure of the flowchart of FIG. 3.

3. Setting Support of Target Quality (Relating to Step S2)

As described above, the customer requirements 11, customer importance rating 12, and customer satisfaction 13 are inputted to the QFD chart, and the work of setting the target quality 14 (namely, a target value of the degree of satisfaction which is a goal of the customer requirements) is carried out. At this time, in the setting support of the target quality, the customer satisfaction of our company and other companies (benchmark objects) are displayed on a scatter diagram or the like, and visual information is displayed such that the QFD operator can easily obtain guidelines such as what customer satisfaction should be aimed for, how should a sales point 14-2 be set, and the like. With respect to the customer satisfaction of other companies, it is possible to show them individually, and the respective maximum values of the customer satisfaction of the other companies are adopted, and comparison between these values and the value of our company can be carried out.

FIG. 8 is a flowchart showing a procedure of the setting support of the target quality. The procedure comprises step S31 of acquiring customer requirements information (the customer requirements 11, customer satisfaction (comparison analysis value) 13 of the respective companies), step S32 of acquiring comparative company selection (individual, all other companies) information, and step S33 of displaying the scatter diagram.

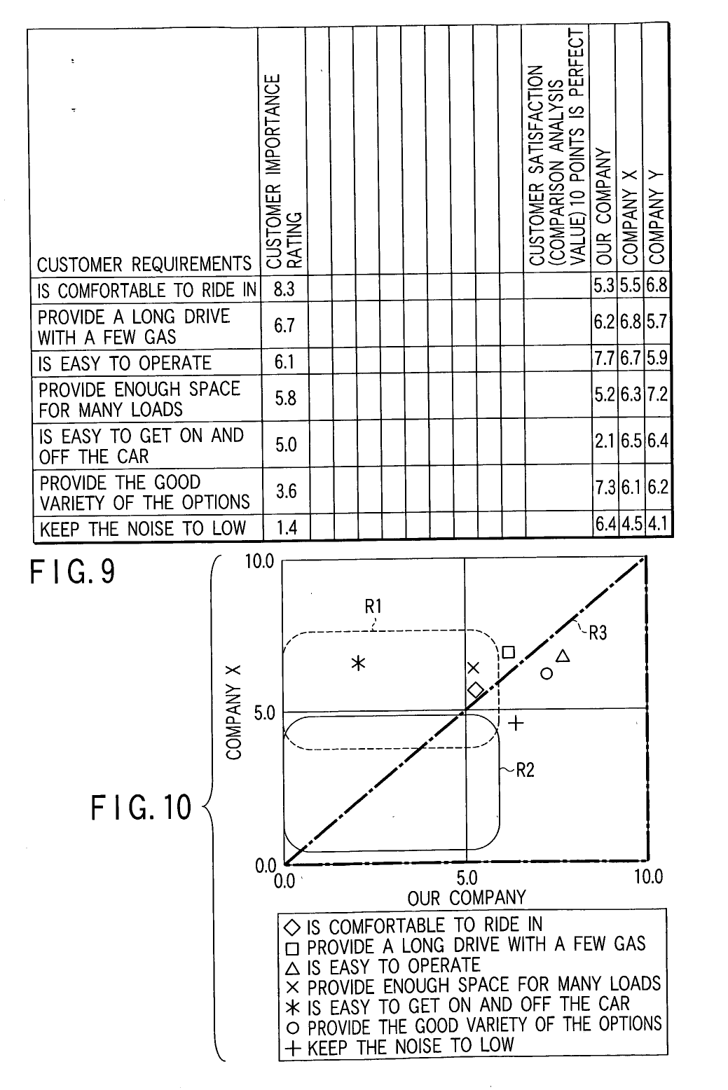

When a company X and a company Y are compared to our company, there are many cases in which comparison is carried out by using, for each of the customer requirements, the company having the larger value among company X and company Y. For example, in accordance with the corresponding positions of the QFD chart shown in FIG. 9, 6.8 of company Y for the customer requirement “Is comfortable to ride in”, and 6.8 of company X for the customer requirement “Provide enough space for many loads” are compared with values of our company.

As one example, a scatter diagram indicated to the QFD operator at the time of comparing our company and company X is shown in FIG. 10.

This scatter diagram is a diagram in which the values of the customer satisfaction of our company and the customer satisfaction of company X are respectively acquired from the QFD chart for each of the customer requirements, and are plotted on a scatter diagram type graph. When a plurality of comparative companies (company X and company Y) exist as in the present embodiment, the maximum value (the most excellent value) for each of the customer requirements may be adopted as described above, and plotted on the scatter diagram. For example, with respect to “Is comfortable to ride in”, 6.8 that is the value of the company Y will be plotted since it is larger than the value 5.5 of the company X.

In the scatter diagram shown in FIG. 10, region R1 in which another company excels over our company is indicated, and an interpretation such as “Although the baseline is not a sales point, this is a region which could become a sales point by our company putting in efforts positively.” is preferably provided to the QFD operator. In region R2 in which the qualities of our company and another company are substantially the same, an interpretation such as “This is a region which could become a sales point in accordance with the setting of the target quality.” is provided, and in region R3 in which our company excels over another company, an interpretation such as “This is a region which could sufficiently be a sales point with the baseline as is.” is provided. In accordance with the scatter diagram display with such interpretations, based on the plotting, onto the respective regions, of the values of our company and the other companies that are the comparison analysis objects, it is preferable that the QFD operator can appropriately and visually determine how the sales point 14-2 (which of 1.0, 1.2, and 1.5) should be set.

Note that the comparison analysis object may be compared with the company Y.

4. Automatically Associating at the Time of Extracting Product Characteristics (Relating to Step S5)

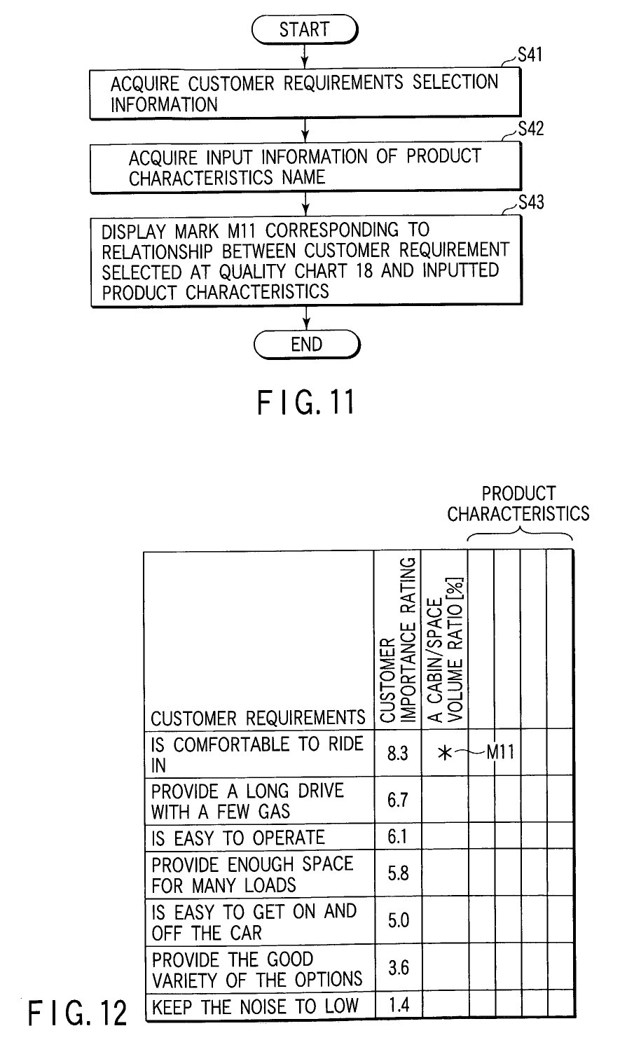

FIG. 11 is a flowchart showing a procedure of automatically associating at the time of extracting the product characteristics 15. The procedure comprises step S41 of acquiring selection information of the customer requirements 11 from the QFD chart, step S42 of acquiring input information of the name of the product characteristics, and step S43 of displaying a mark corresponding to the relationship of the selected customer requirement and the inputted product characteristics, on the quality chart 18 in the QFD chart.

In the work of extracting of the product characteristics on the QFD chart, the QFD operator extracts the technical characteristics (product characteristics) 15 which may influence the customer satisfaction, for each of a plurality of customer requirements 11, and carries out the work of association on the quality chart 18.

While such work is being carried out, when the QFD operator selects the customer requirement which is “Is comfortable to ride in” and extracts the product characteristics which is “A cabin/space volume ratio [%]” and inputs the name into the field of the customer requirements, as the automatic associating of the selected customer requirement and the inputted product characteristics, as shown in FIG. 12, a mark (★) M11 for focusing attention (for showing that there is the need to carry out associating) is displayed in a corresponding cell in the quality chart. On the basis of this display of the mark M11, the QFD operator can reliably carry out associating of the customer requirements and the product characteristics, and omissions of associations can be prevented.

Note that the mark M11 of the automatic associating is strictly temporary for the QFD operator support, and is appropriately replaced with a mark corresponding to the strength of the corresponding relationship in the corresponding (step S7) of the customer requirements and the product characteristics in a later step. Namely, the mark M11 of automatic associating itself does not indicate the strength of the corresponding relationship.

5. Displaying Resetting of Product characteristics When Direction of Improvement is Considered to be Wrong (Relating to Step S5)

When the customer requirements 11 and the product characteristics 15 are associated in the quality chart 18 of the QFD chart, if an instruction is given to associate a customer requirement for which it is thought that the direction of improvement of the product characteristics is wrong, information urging resetting of product characteristics is displayed.

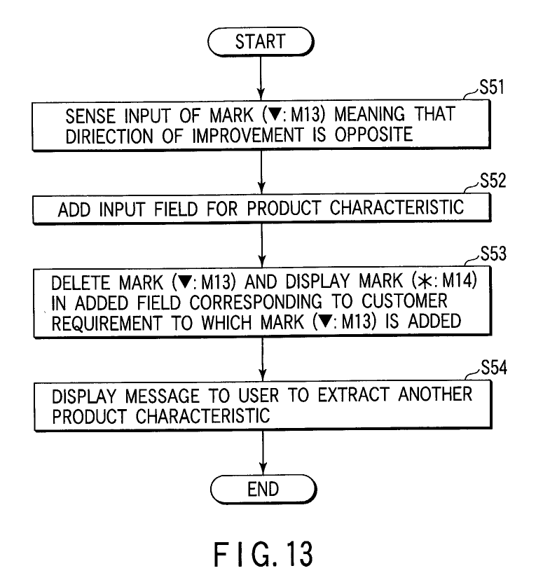

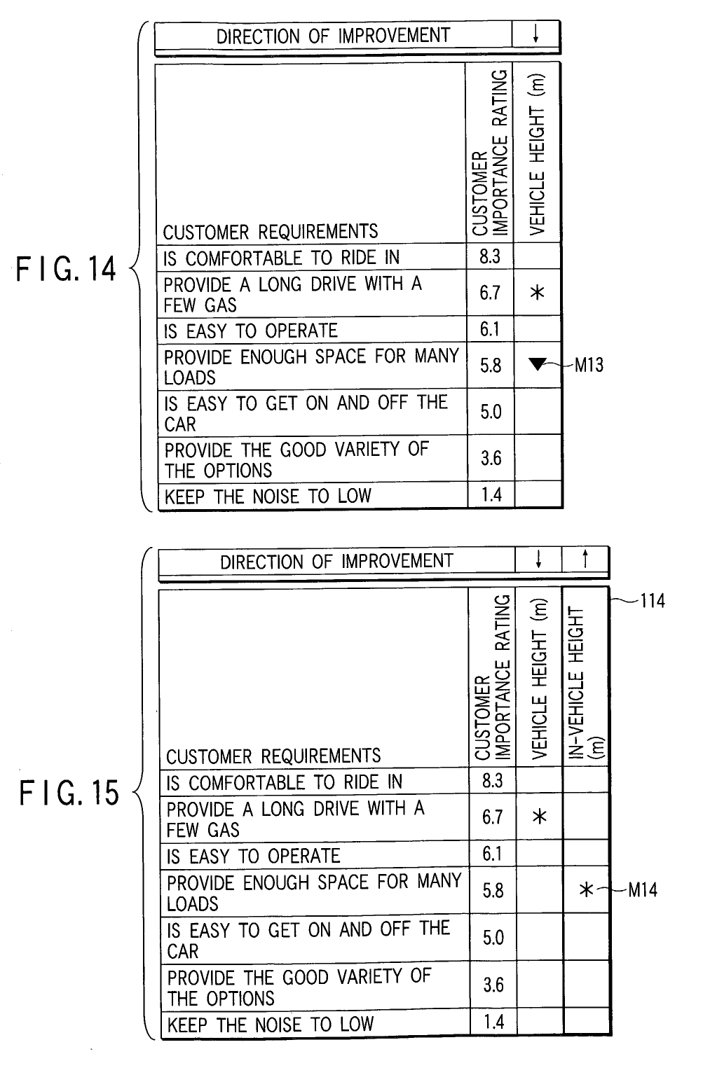

FIG. 13 is a flowchart showing a procedure of displaying the resetting of the product characteristics when the direction of improvement is considered to be wrong, and FIG. 14 and FIG. 15 are tables showing screen changes on a QFD chart at this time.

As shown in FIG. 13, the procedure of indicating the resetting of the product characteristics when the direction of improvement is wrong comprises step S51 of sensing the input of mark (▾) M13 meaning that the direction of improvement is wrong to the quality chart, step S52 of adding an input field for the product characteristics, step S53 of deleting the mark (▾) M13 and displaying a mark (★) M14 at a field corresponding to the product characteristics field to which the mark (▾) M13 was input, and step S54 of displaying a message to the QFD operator to extract another product characteristics.

As described above, as a direction of improvement of the extracted product characteristics, the QFD operator sets and inputs any of a direction of maximizing the value of the product characteristics, a direction of minimizing the value of the product characteristics, and a direction directed to a specific target. Further, these directions of improvement are respectively indicated, for example, by an upward arrow (↑), a downward arrow (⇓), and a double circle (⊙), respectively, on the QFD chart. Further, among the extracted plurality of product characteristics, there are the correlations that if the performance of one product characteristic improves, the performance of another product characteristic deteriorates (strong negative), and the performance of the other product characteristic improves in accordance with the improvement of the one product characteristic (strong positive). Such correlations are inputted in a field of the direction of improvement 17 on the QFD chart (step S5).

At the time of this work, for example, with respect to product characteristic whose direction of improvement is directed upward, when, in a relationship with a customer requirement, there is a downward directed relationship, this corresponding relationship has a different property from a usual relationship. Conventionally, it is processed as it is, or it is simply ignored. However, in the present embodiment, the special mark (▾) M13 as shown in FIG. 14 can be inputted.

When the QFD operator assigns this mark (▾) M13, a predetermined message is displayed so as to extract another product characteristic, and as shown in FIG. 15, another new product characteristic input field 114 is automatically prepared and displayed. If the customer requirement is associated with the product characteristic such that the direction of improvement of the product characteristic is opposite to that determined by the customer requirement, the QFD operator can carry out re-extracting of the product characteristic such that the customer requirement is separated into two product characteristics and the directions of improvement are consistent. In the example of FIG. 14, the direction of improvement of the product characteristic “Height of vehicle” is directed in a direction of lowering the value, and is made to correspond in that direction to the customer requirement “Provide enough space for many loads”, and the mark (▾) M13 whose direction of improvement is opposite is assigned to “Provide enough space for many loads”, by the QFD operator.

Thus, as shown in FIG. 15, the new product characteristic input field 114 is added to the right of the product characteristic “vehicle height”, and the mark (★) M14 for association with the customer requirement “Provide enough space for many loads” is displayed. Here, because the QFD operator is urged to extract another product characteristic with respect to the customer requirement “Provide enough space for many loads”, for example, as another product characteristic, “In-vehicle height” (direction of improvement “↑”) can be extracted.

Note that, it may be automatically sensed that the direction of improvement has become opposite, and the mark (★) M14 may be automatically inputted.

6. Checking of Quality Chart based on Corresponding Relationship Rules (Relating to Step S7)

When the association of the customer requirements and the product characteristics is thoroughly completed, checking of the quality chart 18 is automatically carried out in accordance with corresponding relationship rules. The problems and the reasons therefor (interpretations) are displayed, and further, ways of solving the problems are indicated to the QFD operator. The QFD operator can carry out resetting of the quality chart 18 while carrying out this checking.

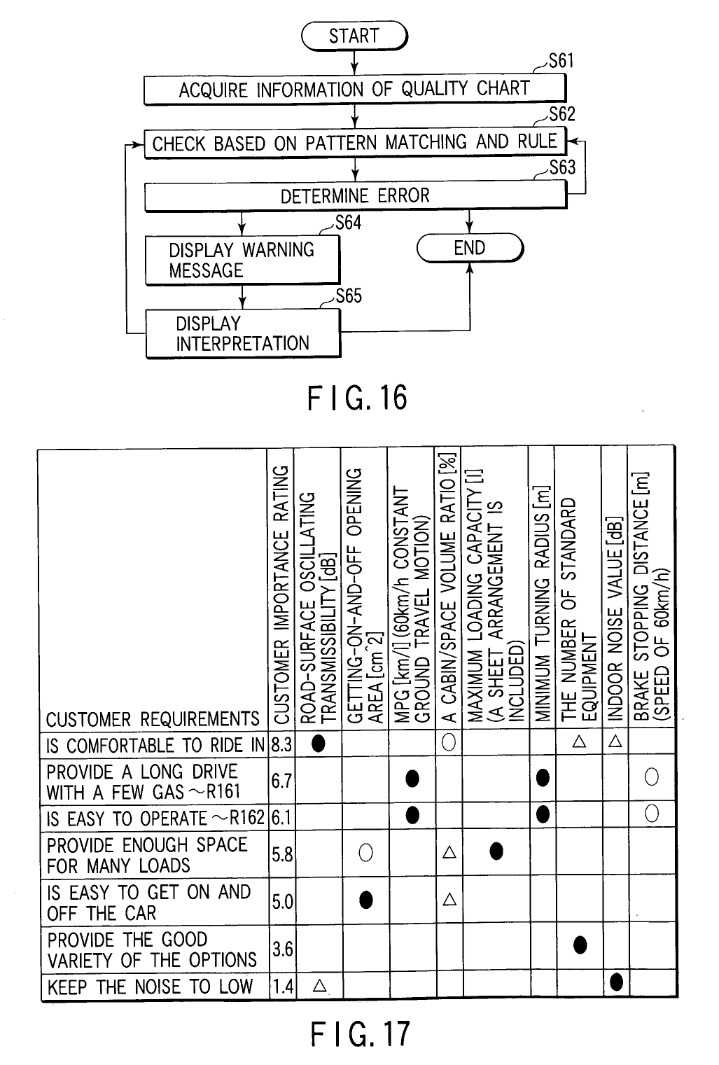

FIG. 16 is a flowchart showing a procedure of such checking of the quality chart 18. The procedure comprises step S61 of acquiring information of the quality chart 18 from the QFD chart, step S62 of checking based on pattern matching and rules, step S63 of carrying out error checking, step S64 of displaying a warning message when there is determined to be an error in step S63, and step S65 of displaying interpretations.

The following rules are considered as examples of the rules of relationship checking to be applied in step S62.

(1) There is a row in the quality chart 18 having only a blank field or a weakness (triangle mark).

(2) There is a column in the quality chart 18 having only a blank field or a weakness (triangle mark).

(3) The number of marks in the quality chart 18 is too large.

(4) There are two or more strengths (black circle marks) with respect to each of the customer requirements.

(5) The number of medium (white circle marks) or weakness (triangle marks) are too large with respect to each of the customer requirements.

(6) There is the same pattern in the separate rows.

(7) There is the same pattern in the separate columns.

(8) Different degrees of strength have the same mark.

(9) The degrees of strength for strong marks (black circle marks) are different from others.

(10) The degrees of strength for medium marks (white circle marks) do not fall within a given range.

In the quality chart 18, due to pattern matching being carried out with respect to the rows of the customer requirements and the columns of the product characteristics respectively, a row or column which violates a rule is sensed, and an interpretation and a way of solving relating to that rule are provided. For example, as shown in FIG. 17, for the customer requirement “Provide enough space for many loads” R161 and “Is easy to operate” R162, association to the product characteristics with the same pattern is carried out, and this violates above rule (6). In this case, a predetermined warning message is displayed, and then, an interpretation such as “There is the possibility that the degree of abstraction levels of customer requirements are not complete. In order to adjust the balance of the correspondence (quality chart 18), please express the two customer requirements as one customer requirement.” or the like is provided to the QFD operator. This is because, if similar customer requirements are treated as two customer requirements, the weight thereof with respect to the product characteristics will be double.

7. Validity Evaluation of Quality Chart 18 by Calculating Priority (Relating to Step S8)

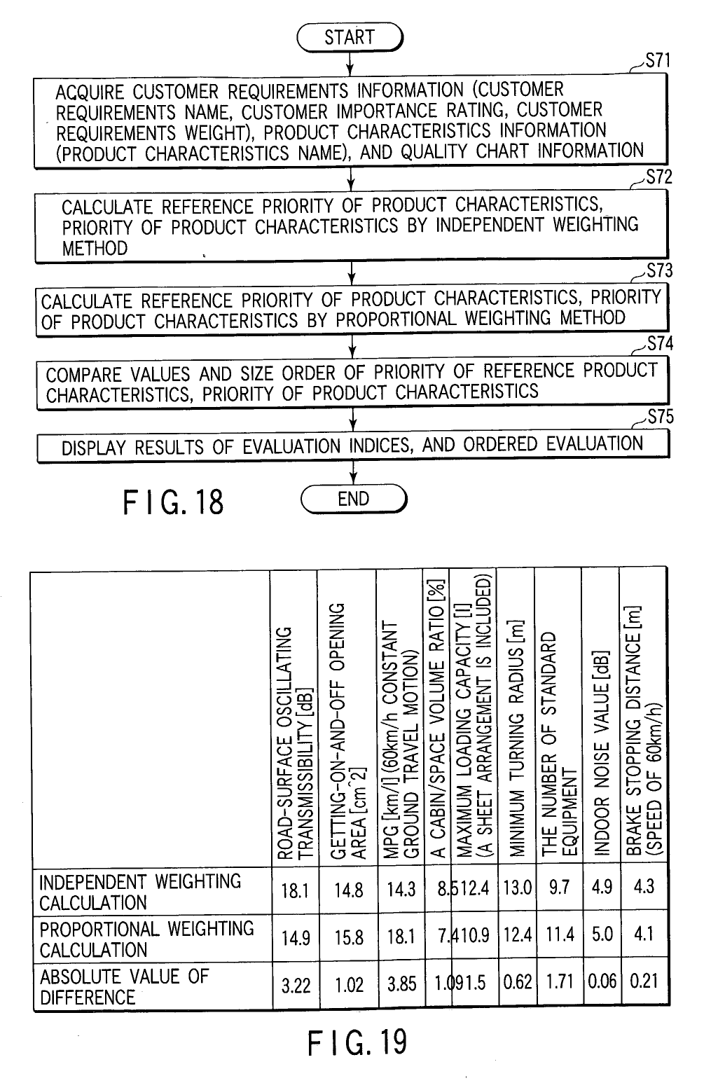

FIG. 18 is a flowchart showing a procedure of validity evaluation of the quality chart 18 by calculating the priority. Validity is a quality that suppresses the dispersion between respective QFD operators, and ensures objectivity within the company. The procedure comprises step S71 of acquiring customer requirements information (customer requirements name 11, customer importance rating 12, customer requirements weight 21), product characteristics information (product characteristics name 15), and quality chart 18 information, step S72 of calculating the reference priority 24-1 of product characteristics and priority 24-2 of product characteristics by the independent weighting method, step S73 of calculating the reference priority 24-1 of product characteristics and priority 24-2 of product characteristics by the proportional weighting method, step S74 of comparing the values and the size order of the reference priority 24-1 of product characteristics and priority 24-2 of product characteristics, and step S75 of carrying out display of the results of evaluation indices and the ordered evaluation.

When associating of the customer requirements and the product characteristics is completed, the priority of product characteristics 24 can be calculated. As the calculating method, for example, there are following two methods (independent weighting method and proportional weighting method).

In the independent weighting method, the priories are calculated by the total sum (i=1 to n) of the importance rating of the customer requirement i×the value of the corresponding relationship between the customer requirements and a desired product characteristic.

On the other hand, in the proportional weighting method, the priories are calculated by the total sum (i=1 to n) of the importance rating of the customer requirement i×the value of the corresponding relationship between the customer requirements and a desired product characteristic/the total of the value of the corresponding relationship relating to the customer requirement i.

FIG. 19 shows the priorities (not a calculated value itself, but converted to %) of the customer requirements calculated by the independent weighting method and the proportional weighting method, and the absolute value (evaluation indices of the quality chart 18) of the difference between these priorities.

Generally, the independent weighting method is recommended because the strength of the corresponding relationship (weighting) of the QFD operator is reflected as is, and the proportional weighting method is preferred for a beginner having no confidence in assigning strengths of the corresponding quality chart 18. The priorities are calculated by using these two methods, and indices for comparing values for every product characteristic is calculated. Evaluation of the quality chart 18 is carried out based on these indices, and the QFD operator is urged to look over the quality chart 18 as needed. As an example of the indices, if it is the total sum of the absolute value of the differences of the priorities, how much of a difference there is can be determined quantitavely and appropriately. When the index exceeds a predetermined threshold value, it means that the balance of the weight for correspondence is not very preferable, and this is indicated to the QFD operator. In accordance with this, the QFD operator can carry out reexamination of the quality chart 18.

For example, when priorities such as in FIG. 19 are respectively calculated, the value of evaluation index is 3.22+1.02+3.85+1.09+1.5+0.62+1.71+0.06+0.21=13.28. Note that, not only the difference of the priority, but also ordering of the values is added to the index.

8. Checking Product Characteristics and Association by Customer Satisfaction and Benchmark Value (Relating to Step S9)

When the respective benchmark values 19 of the product characteristics of the benchmark company are inputted with respect to the product characteristics, from the relationship between the customer satisfaction 13 of the customer requirements and the benchmark value 19 of the product characteristics, whether or not there are contradictions therein is checked. When there is a contradiction, it is supposed that there is an omission in extracting the product characteristics or an error in correspondence.

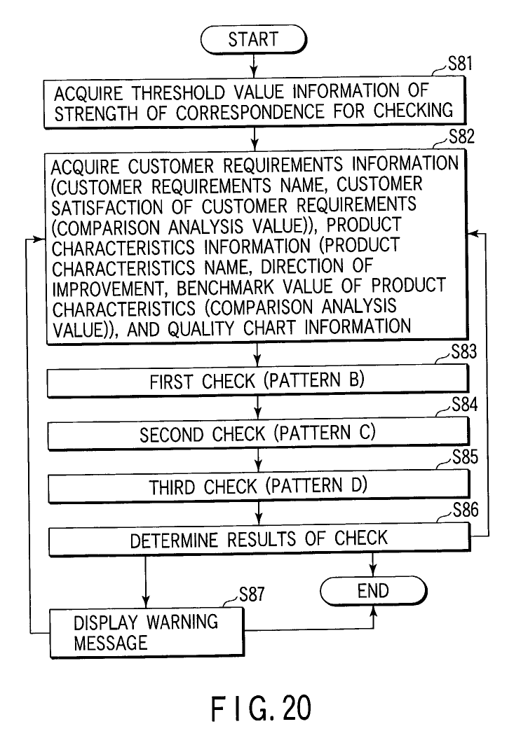

FIG. 20 is a flowchart showing a procedure of checking product characteristics and association by the customer satisfaction and the benchmark value. The procedure comprises step S81 of acquiring threshold value information of the strength of the correspondence carrying out checking, step S82 of acquiring, from the QFD chart, customer requirements information (customer requirements name 11, customer satisfaction 13 of customer requirements (comparison analysis value)), product characteristics information (product characteristics name 15, direction of improvement 17, benchmark value 19 of product characteristics (comparison analysis value)), and quality chart 18 information, step S83 of implementing a first check (pattern B), step S84 of implementing a second check (pattern C), step S85 of implementing a third check (pattern D), step S86 of carrying out a determination of the results of checking, and step S87 of displaying a warning message when an error such as a contradiction or the like arises in the results of checking in step S86.

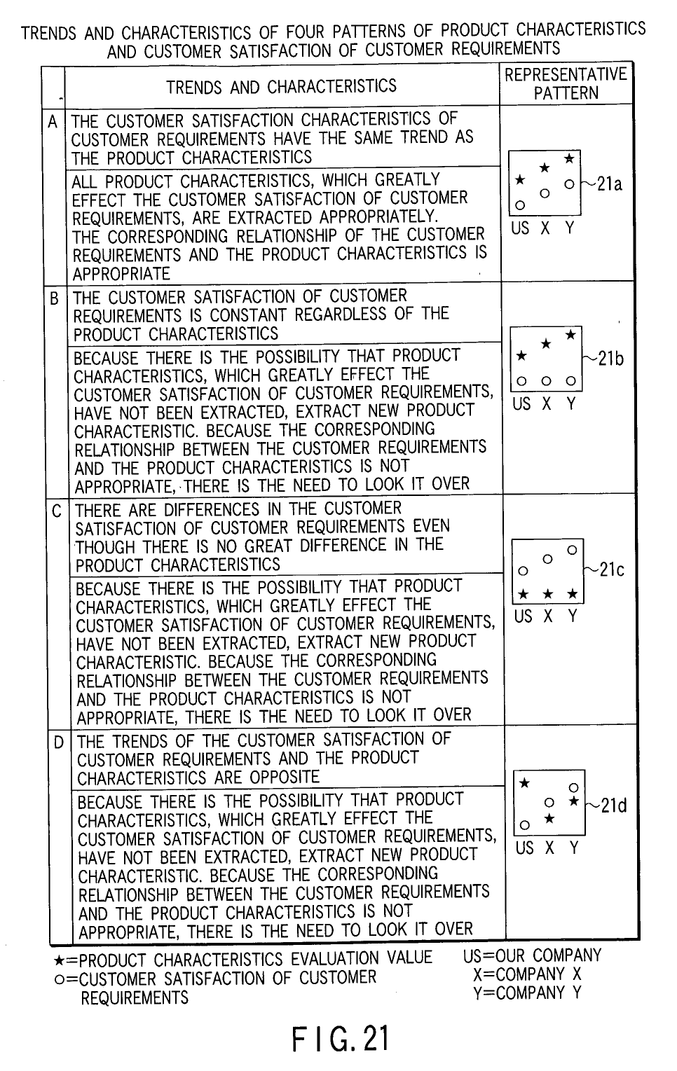

As the quality chart 18 between the product characteristics and the satisfaction degree of the customer requirements, there are four patterns of A through D as shown in FIG. 21. In FIG. 21, patterns A through D show the benchmark value of the product characteristics and the satisfaction degree of the customer requirements among our company, company X, and company Y.

In FIG. 21, with respect to patterns B, C and D, there is the possibility of an omission in the extraction of the product characteristics, or of a problem in the corresponding relationship. Here, the following methods have been conceived of as ways of checking. Firstly, a case where the direction of improvement is directed upward is assumed. When the direction of improvement is directed downward, it suffices to think that the axis of the product characteristics values is turned upside-down.

First Check (Pattern B)

When the satisfaction degree of the customer requirements is constant regardless of the benchmark value of the product characteristics, a ratio of the maximum value and the minimum value of the product characteristics evaluation value is compared with a threshold value, for example, 1.2. If the ratio is the threshold value or more, (i) because there is the possibility that product characteristics, which greatly effect the satisfaction degree of the customer requirements, has not been extracted, there is the need to extract a new product characteristic, or (ii) because the corresponding relationship between the customer requirements and the product characteristics is not appropriate, there is the need to look it over, and therefore, an error message is outputted.

Second Check (Pattern C)

When there are differences in the satisfaction degree of the customer requirements even though there is no great difference in the benchmark value of the product characteristics, the difference between the maximum value and the minimum value of the satisfaction degree of the customer requirements is compared with a threshold value, for example, 1.0. If the difference is the threshold value or more, (i) because there is the possibility that product characteristics, which greatly effect the satisfaction degree of the customer requirements, has not been extracted, there is the need to extract a new product characteristics, or (ii) because the corresponding relationship between the customer requirements and the product characteristics is not appropriate, there is the need to look it over, and therefore, an error message is outputted.

Third Check (Pattern D)

When the trends of the satisfaction degree of the customer requirements and the benchmark value of the product characteristics are opposite, (i) because there is the possibility that product characteristics, which greatly effect the satisfaction degree of the customer requirements, has not been extracted, there is the need to extract a new product characteristic, or (ii) because the corresponding relationship between the customer requirements and the product characteristics is not appropriate, there is the need to look it over, and therefore, an error message is outputted. Note that, when the direction of improvement is “⇓”, −1 is multiplied, and a check of the large/small relationship is carried out.

The first, second, and third checks are carried out by using the benchmark value of the product characteristics and the value of the customer satisfaction relating to each of the customer requirements, for each of the customer requirements. When a check is applicable, the combination of the customer requirements and the product characteristics is displayed. Further, when a check is applicable, although there is not necessarily a problem, an omission in extracting or a corresponding error can be prevented by urging reexamination. In particular, when a point in which the customer requirements and the product characteristics correspond by a strong relationship (black circle mark: association level is 9) is checked, there is the need to reexamine whether or not the product characteristics, which most greatly effect the customer requirements, has been appropriately extracted, and whether or not the correspondence is appropriate.

The method of implementing the check may be appropriately changed as needed, such as the above-described checks are carried out for only the strong relationship, or the checks are carried out for only the strong relationship and the usual relationship or the like. Further, because there is the possibility of error with respect to the large/small relationship, an error of up to what value cannot be included in the reversal of the large/small relationship is selected, or is set by being estimated from the benchmark value.

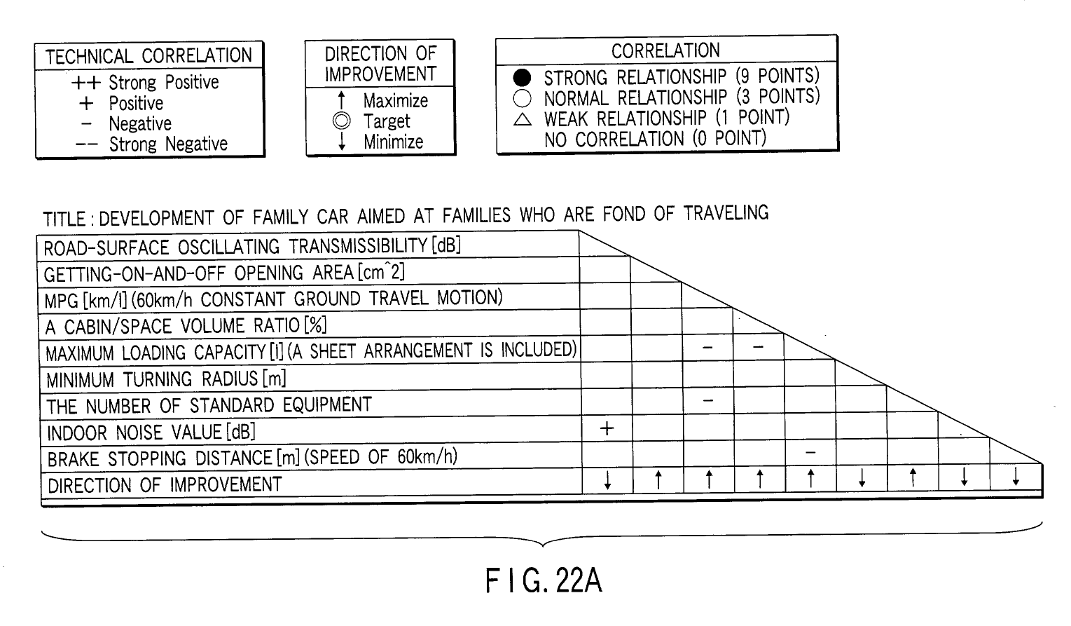

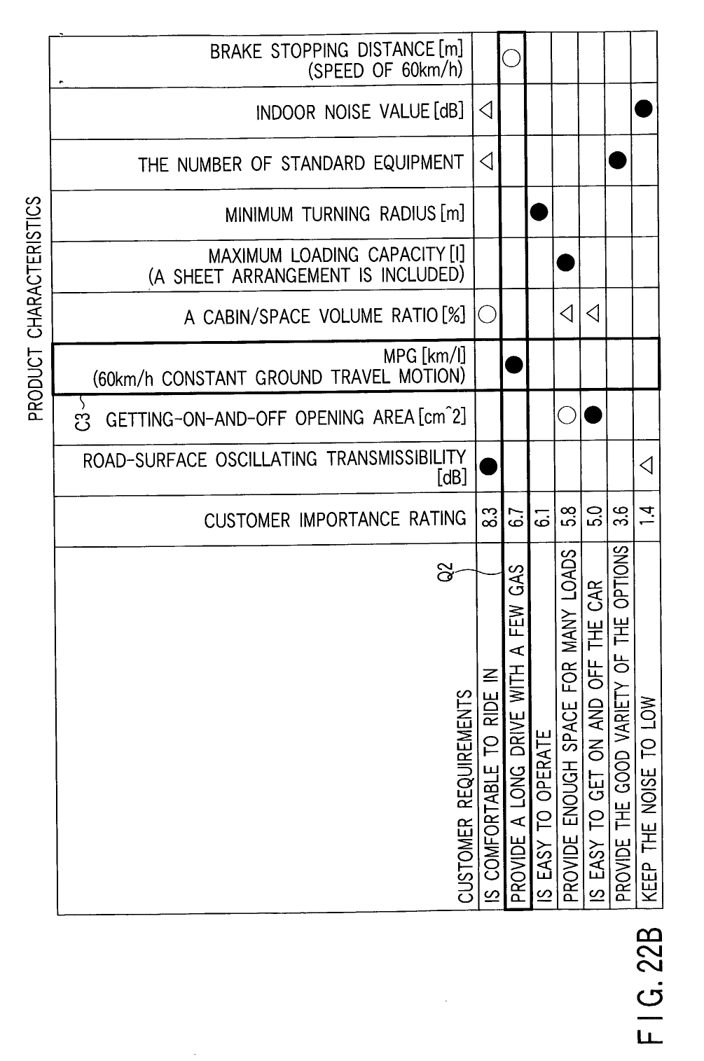

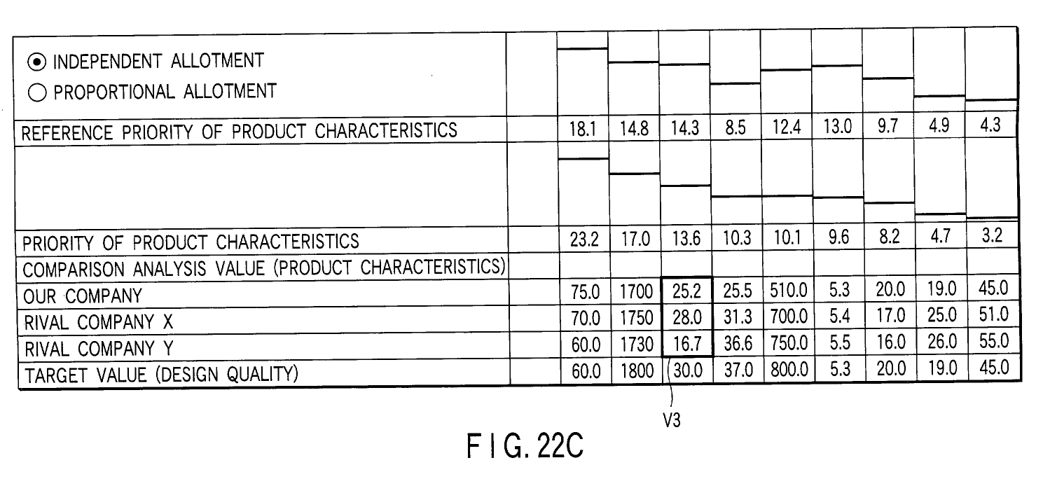

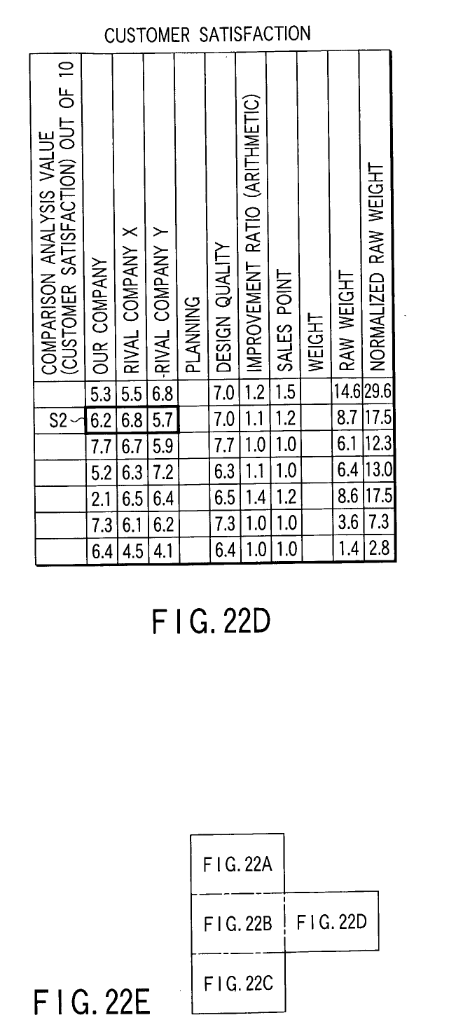

In the case of the present embodiment as shown in FIGS. 22A to 22D, the values of our company, company X, and company Y in the customer satisfaction relating to customer requirement Q2 “Provide enough space for many loads” are respectively 6.2, 6.8, and 5.7 as shown by S2. The benchmark values of our company, company X, and company Y for the product characteristic C3 “Mpg [km/l] (60 km/h constant ground travel motion)” are respectively 25.2, 16.7, and 28.0 as shown by V3. Namely, the relationship of the customer satisfaction is company Y<our company<company X, whereas it is known that the relationship of the comparison analysis value of the product characteristics is company X<our company<company Y. This is sensed in the check of the third check (pattern D) that is “there is a point where the trends of the satisfaction degree of the customer requirements and the product characteristics evaluation value are opposite.”

9. Checking Design Quality by Customer Satisfaction and Benchmark Value (Relating to Step S10)

After the product characteristics is corresponded to the customer requirements and the benchmark is completed, a design quality (goal) 20 of the product characteristics is set in order to satisfy the target quality. Here, the target value of each of the product characteristics is determined without considering a realizing means, and the value is not systematically derived, but determined by the QFD operator from the importance rating of the product characteristics or the results of the benchmark. Therefore, in order to carry out design without going backward, there is the need to determine whether or not the set value is appropriate before entering the designing phase. The relationship between both is derived from the satisfaction degree of the customer requirements of the product and the benchmark value of the other company of the product characteristics related thereto, and whether or not there is a contradiction between the set target quality and the design quality is checked. When there is a contradiction in the results of the check, resetting of the value of the design quality is urged to the QFD operator, and a deduction of mistakes in setting the design quality is attempted.

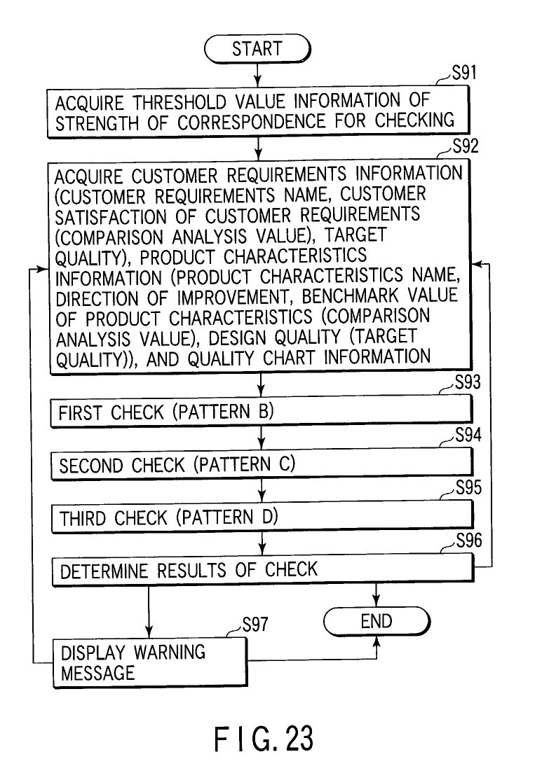

FIG. 23 is a flowchart showing a procedure of checking the design quality by the customer satisfaction and the benchmark value. The procedure comprises step S91 of acquiring threshold value information of the strength of the correspondence carrying out checking, step S92 of acquiring, from the QFD chart 18, customer requirements information (customer requirements name 11, satisfaction degree of the customer requirements (comparison analysis value) 13, target quality 14), product characteristics information (product characteristics name 15, direction of improvement 17, benchmark value 19 of product characteristics (comparison analysis value), design quality (goal) 20), and quality chart information, step S93 of implementing a first check (pattern B), step S94 of implementing a second check (pattern C), step S95 of implementing a third check (pattern D), step S96 of carrying out a determination on the results of checking, and step S97 of displaying a warning message when an error such as a contradiction or the like arises in the results of checking in step S96. Here, the following methods are conceived of as ways of checking. Firstly, a case where the direction of improvement is directed upward is assumed. When the direction of improvement is directed downward, it suffices to think that the axis of the product characteristics values is turned upside down.

First check (Pattern B)

When the target quality 14 equals to the customer satisfaction 13, the benchmark value 19 of the product characteristics is compared with the target value 20. If the ratio of the larger one of the benchmark value 19 and the target value 20 and the smaller one is equal to or more than 1.2, the check is failed.

Second check (Pattern C)

When the target value 20 equals to the benchmark value 19 of the product characteristics, the target quality 14 is compared with the customer satisfaction 13. If the absolute value of the difference between the benchmark value 19 and the target value 20 is equal to or more than 1.0, the check is failed.

Third Check (Pattern D)

It is checked whether the relationship between the satisfaction degree of the customer requirements and the target quality 14 is consistent with the relationship between the benchmark value and the design quality 19. If there is at least one inconsistency in the relationships, the check is failed. Note that, when the direction of improvement is “⇓”, −1 is multiplied, and a check of the large/small relationship is carried out.

The first, second, and third checks are carried out by using the benchmark value of the product characteristics and the customer satisfaction value relating to the respective customer requirements, for each of the customer requirements. When the check is failed, the combination of the customer requirements and the product characteristics is displayed. Further, when the check is failed, although there is not necessarily a problem, an omission in extraction or a correspondence error can be prevented by urging reexamination. In particular, when a point in which the customer requirements and the product characteristics correspond by a strong relationship (black circle mark: association level is 9) fails to pass the checks, there is the need to reexamine whether or not the product characteristics, which most greatly effect the customer requirements, has been appropriately extracted, and whether or not the correspondence is appropriate.

The method of implementing the check may be appropriately changed as needed, such as the above-described checks are carried out for only the strong relationship, or the checks are carried out for only the strong relationship and the usual relationship, or the like. Further, because there is possibility of error with respect to the large/small relationship, an error of up to what value cannot be included in the reversal of the large/small relationship is selected, or is set by being estimated from the benchmark value.

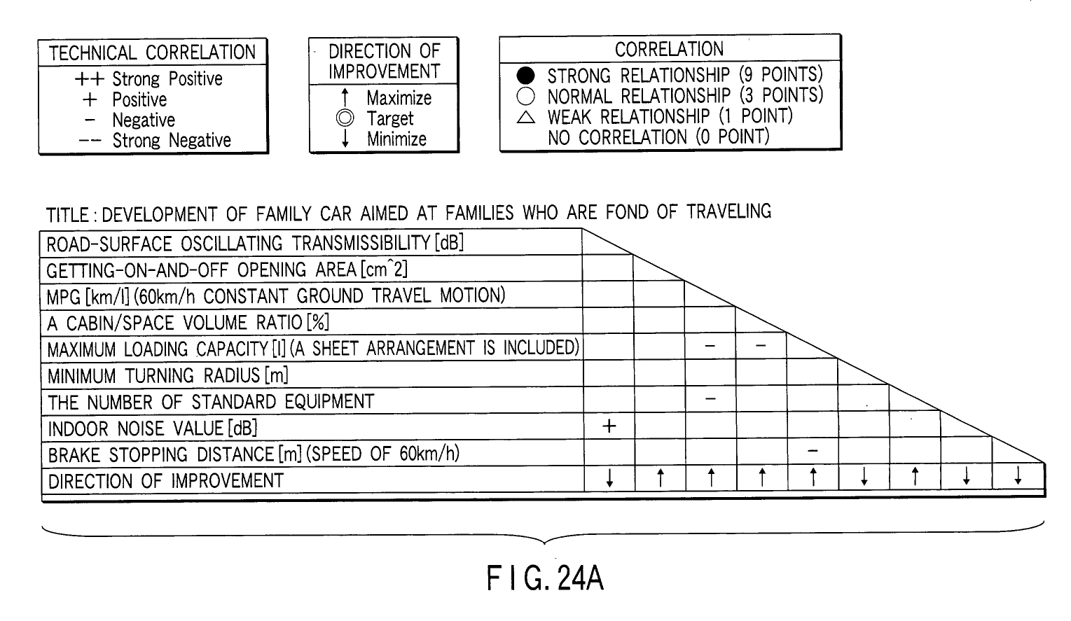

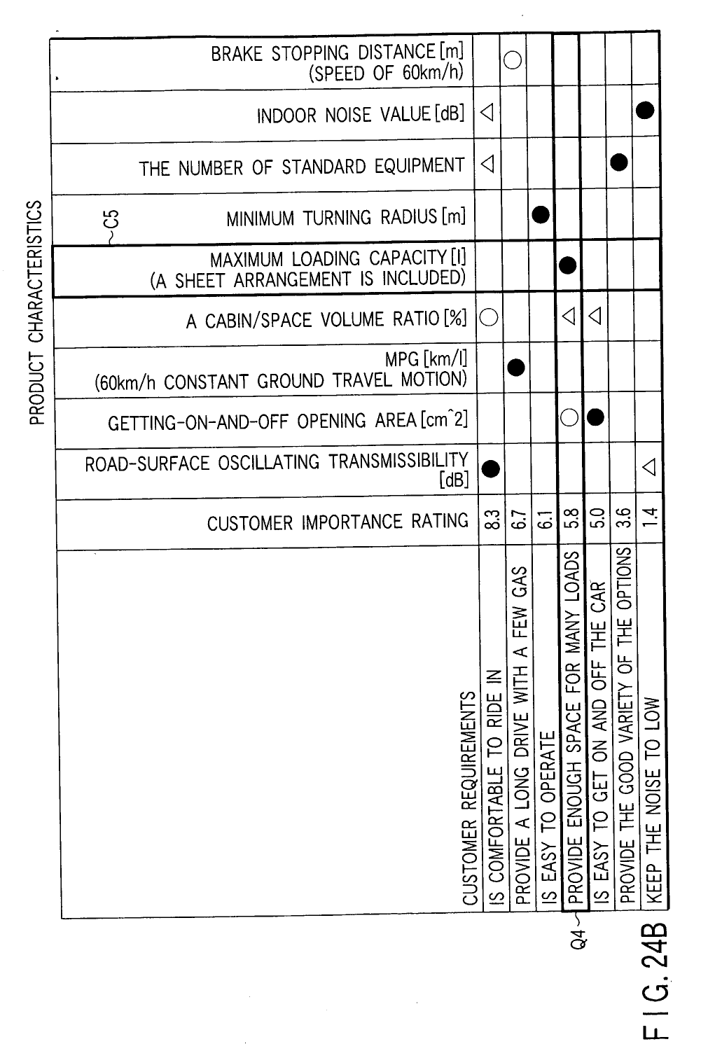

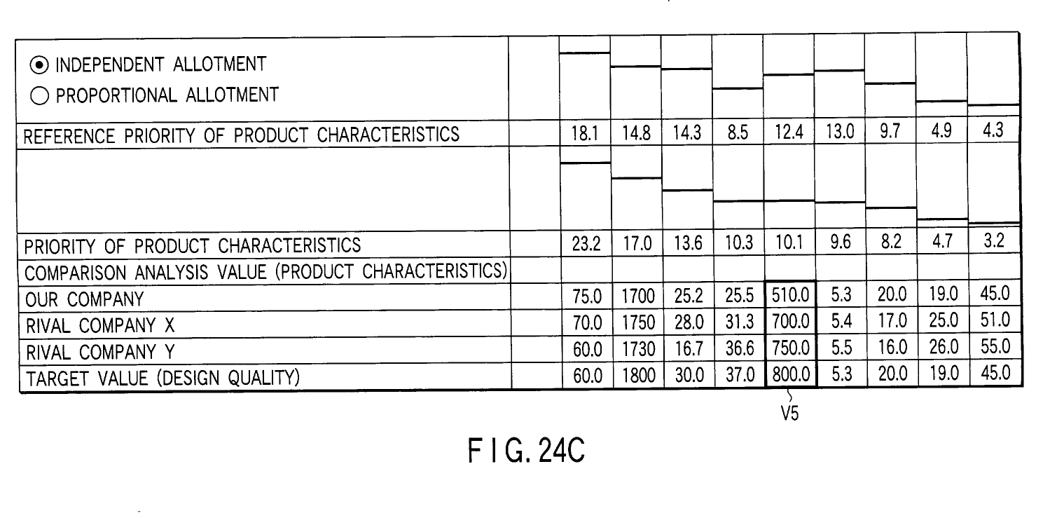

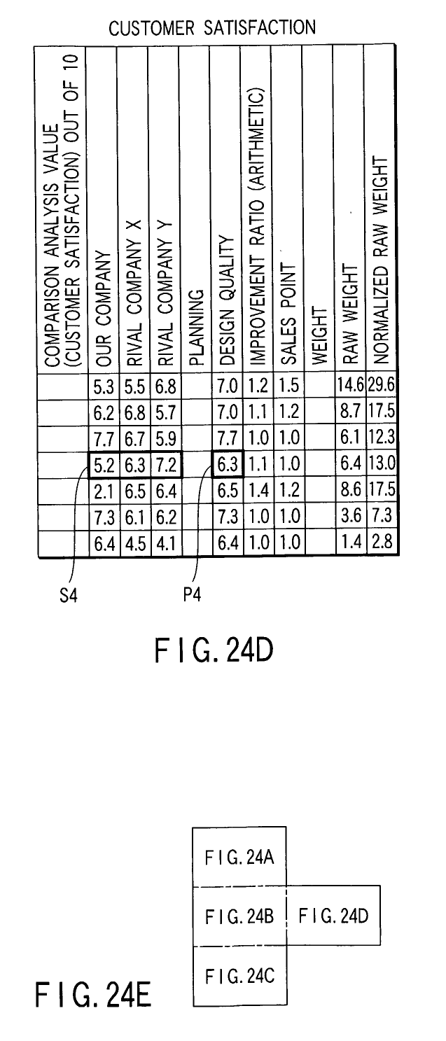

In the case of the present embodiment as shown in FIGS. 24A to 24D, with respect to the design quality P4=6.3 of the customer requirement Q4 “Provide enough space for many loads”, the value of the design quality (goal) V5 of the product characteristic CS “Maximum loading capacity [1] (a seat arrangement is included)” is set to 520.0. However, the benchmark value V5 of the product characteristics is 700.0 with respect to the customer satisfaction S4=6.3 of company X. Regardless of the fact that the customer satisfaction values are the same, because the ratio of the maximum value and the minimum value of the product characteristics is 1.2 times or more, this corresponds to the check item of the first check (pattern B) “the satisfaction degree of the customer requirements is constant the regardless of product characteristics”.

10. Displaying Guidelines of Design Quality by Customer Satisfaction and Benchmark Value (Relating to Step S10)

Values of the design quality (the goal) corresponding to the values of the target quality are calculated from the relationship between the satisfaction degree of the customer requirements with respect to the corresponding customer requirements and the benchmark value of the product characteristics, for each of the product characteristics, and these values are displayed as a guideline. The QFD operator can carry out appropriate setting of the design quality with reference to these guideline values.

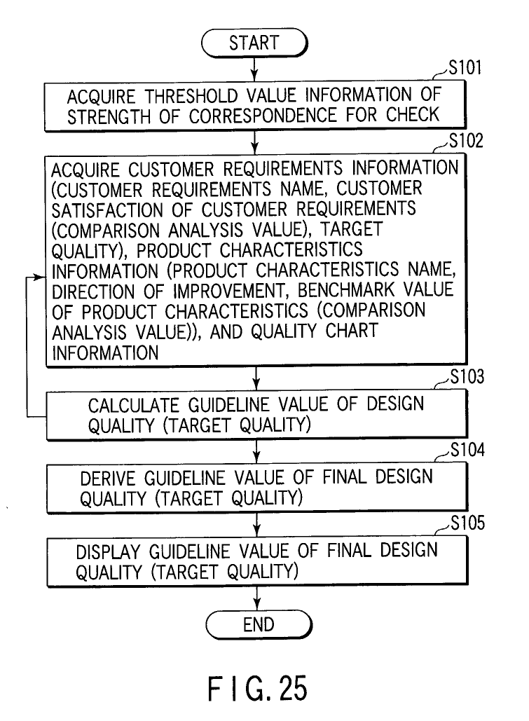

FIG. 25 is a flowchart showing a procedure of displaying the guideline of the design quality. The procedure comprises step S101 of acquiring threshold value information of the strength of the correspondence carrying out checking, step S102 of acquiring customer requirements information (customer requirements name 11, satisfaction degree of the customer requirements (comparison analysis value) 13, target quality 14), product characteristics information (product characteristics name 15, direction of improvement 17, benchmark value 19 of product characteristics (comparison analysis value)) and quality chart information 18, step S103 of calculating a guideline of the design quality (goal) 20 for every combination of the associated product characteristics and the customer requirements, step S104 of deriving a guideline of the final design quality (goal) 20 for each of the product characteristics, and step S105 of displaying the guideline of the final design quality (goal).

One example of the method of calculating the above-described guideline will be described in relation to cases where the directions of improvement are “↑” and “⇓”. The maximum value and the minimum value of the values of the satisfaction degree of the customer requirements relating to the product characteristics, including our company and other companies, are extracted. A linear equation of the satisfaction degree of the customer requirements and the benchmark value of the product characteristics is established from the benchmark value of the product characteristics at the maximum value and the minimum value. Further, the value of the product characteristics at the time when the satisfaction degree of the customer requirements is the target quality is calculated from this linear equation. This becomes the guideline of the design quality (goal). Assuming that the maximum value of the customer satisfaction is C1, the product characteristics value at that time is E1, the minimum value of the customer satisfaction is C2, and the product characteristics value at that time is E2, the value of the design quality (the goal) corresponding to the target quality (based on a relationship between the satisfaction degree of the customer requirements and the benchmark value) can be expressed by the following linear equation.

Design Quality (Goal)

$$\begin{matrix}Design quality ( goal ) = ( E1 - E2 ) / ( C1 - C2 ) \times target quality + \\ ( ( C1 \times E2 ) - ( C2 \times E2 ) ) / ( C1 - C2 )\end{matrix}$$

However, when the maximum value and the minimum value are the same value, the value of the design quality (goal) cannot be derived.

When one product characteristic is associated with a plurality of customer requirements, in accordance with this method, although the guidelines of the values of a plurality of design qualities (target qualities) are calculated, the value having the stronger corresponding relationship is adopted as the value of the design quality (goal) of the product characteristics. When there are a plurality of values having the strongest corresponding relationship, when the direction of improvement is “↑”, the largest value is adopted as the value of the design quality (goal), and when the direction of improvement is “⇓”, the smallest value is adopted as the value of the design quality (goal).

Note that the design quality (the goal) corresponding to the target quality (based on a relationship between the satisfaction degree of the customer requirements and the benchmark value) may be determined by using a regression analysis method or a least squares method.

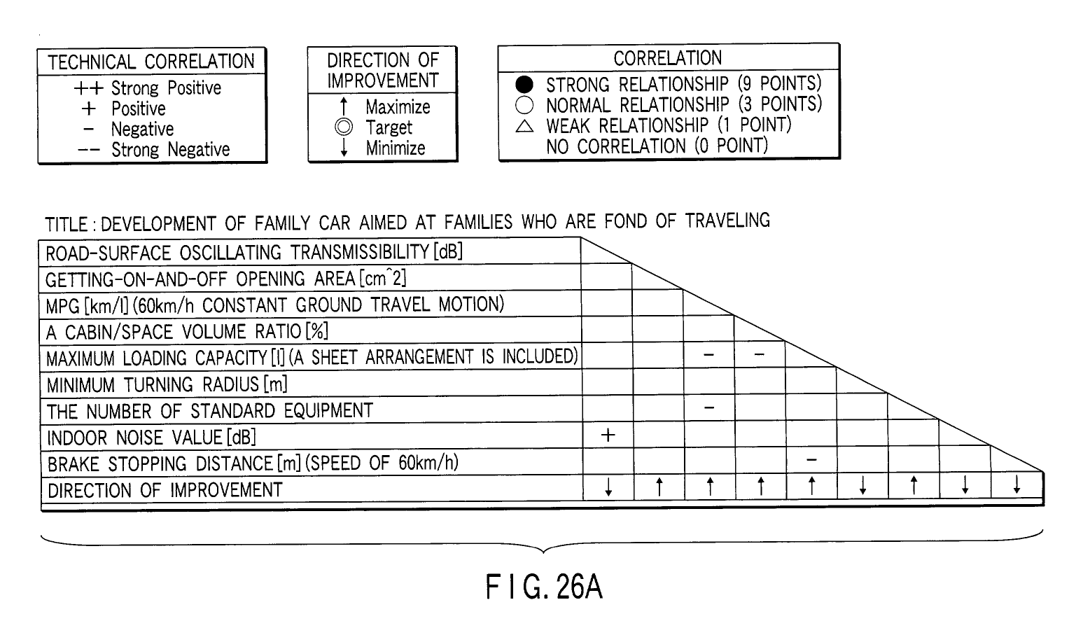

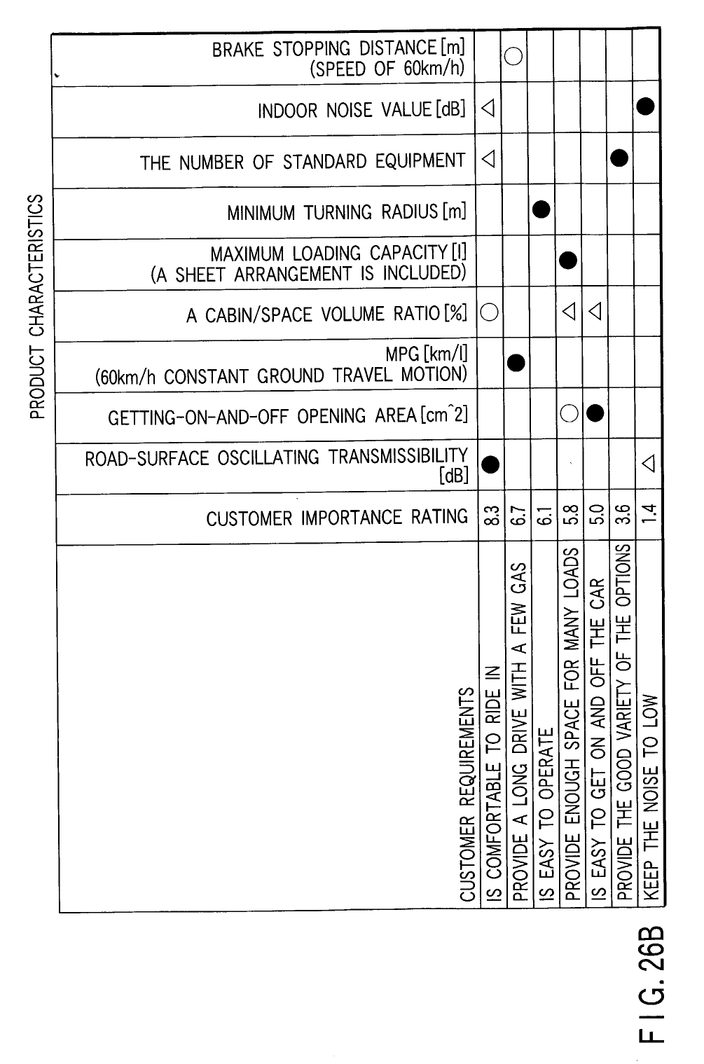

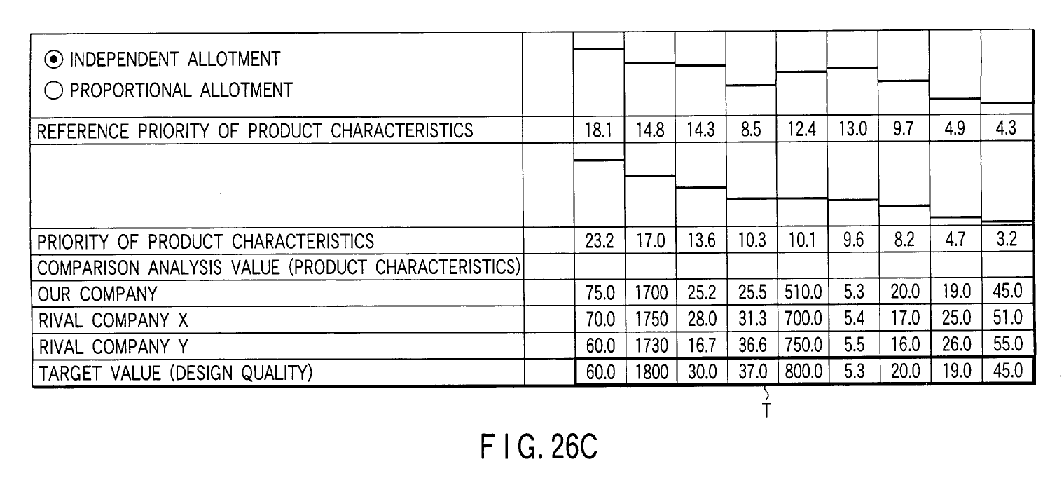

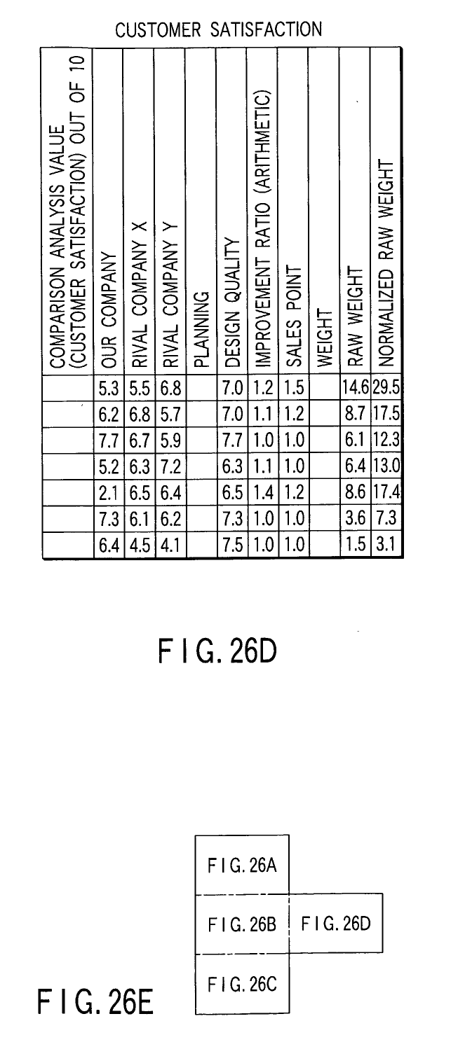

In the case of the present embodiment shown in FIGS. 26A to 26D, for example, when the satisfaction degree of the customer requirements “Is comfortable to ride in” are 5.3 (our company), 5.5 (company X) and 6.8 (company Y), and the benchmark values with respect to the product characteristic “Road vibration transmission rate [dB]” associated therewith are 75 (our company), 70 (company X) and 60 (company Y), if the design quality of the customer requirements is set to 7.0, the guideline value T of the value of the design quality (goal) of “Road vibration transmission rate [dB]” is calculated as follows.

$$\begin{matrix}T = ( 60 - 75 ) / ( 5.6 - 5.3 ) \times target quality + \\ ( ( 5.6 \times 75 ) - ( 5.3 \times 60 ) ) / ( 5.6 - 5.4 ) \\ = 58.0\end{matrix}$$

In this way, with reference to the guideline value displayed on the QFD chart, the QFD operator can easily and appropriately set the design quality (goal).

Here, if VoC information relating to the product characteristics is extracted from the VoC data 7 associated with the customer requirements registered initially, comparison with the specification desired by the customer in VoC of the design quality of the product characteristics, or the like can be carried out. For example, with respect to the product characteristic “Mpg [km/l] (60 km/h constant ground travel motion)”, specification information (a value expressing what the fuel consumption is desired to be) of the requirement of the customer relating to the related customer requirement “Provide enough space for many loads” is extracted with reference to the VoC data 7, and is displayed. Effective evaluation relating to the voice of the customer from the QFD operator and the quality set as a target can thereby be speedily and easily carried out.

As described above, in accordance with the present embodiment, because the QFD support is carried out at the respective stages of a series of QFD operations or at all times, the QFD operator can in advance prevent omissions in extraction, data errors, contradictions and the like, and can smoothly carry out QFD activities having high informational value.

Next, another embodiment of the present invention will be described. In the following embodiment, portions corresponding to those of the first embodiment are denoted by the same reference numerals, and detailed description thereof is omitted.

Second Embodiment

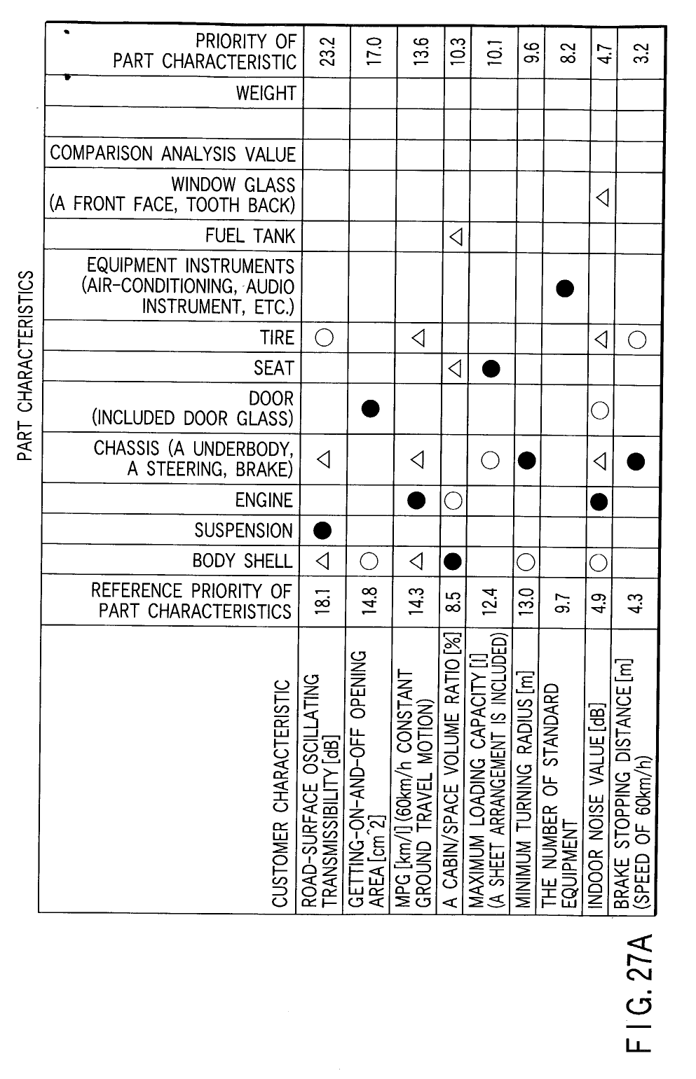

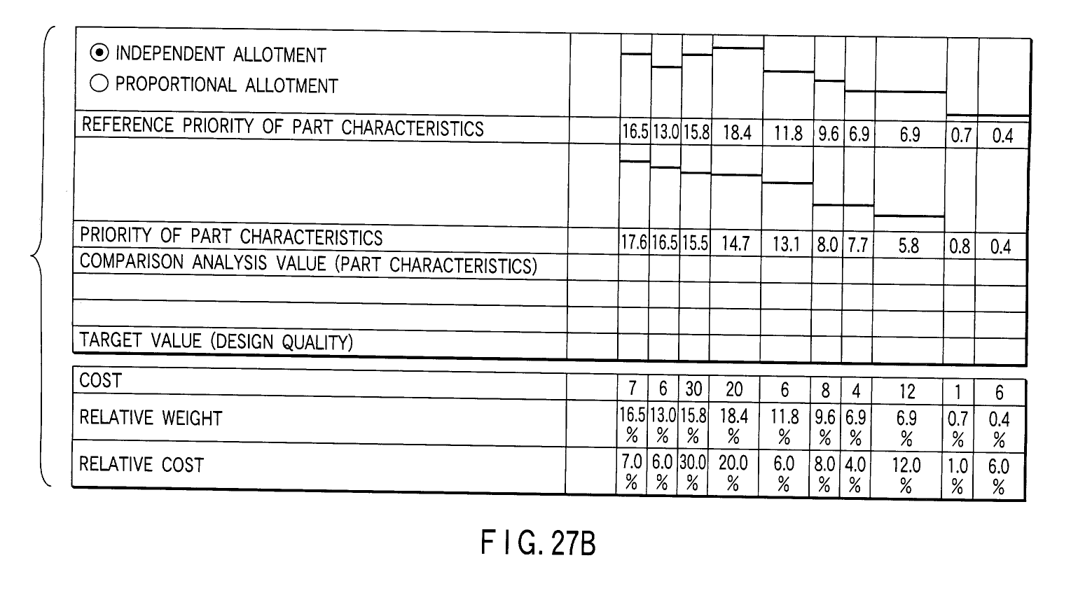

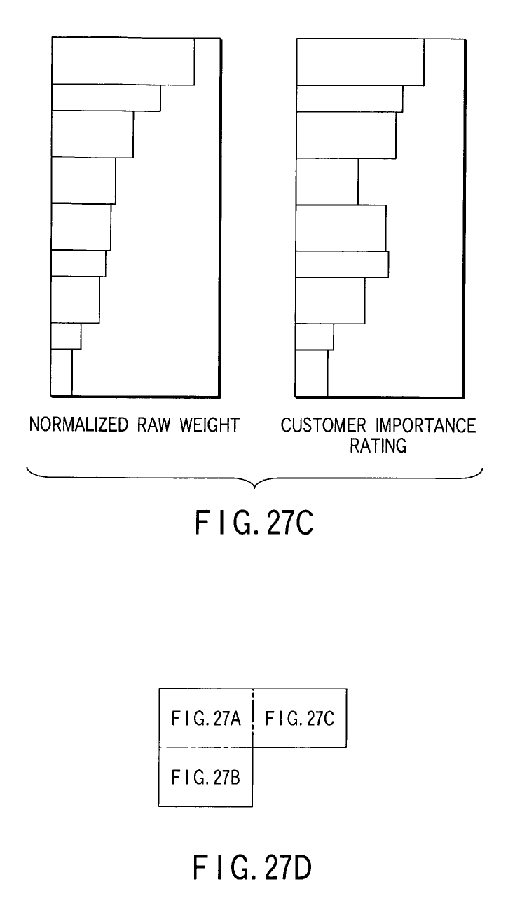

Although the QFD (QFD-I) of the first embodiment carries out development from the customer requirements to the product characteristics, further, quality development from the product characteristics to the product part may be can be carried out. This is called QFD-II. At the time of operation of the QFD-II as well, items such as parts, product characteristics, customer requirements and the like are associated with VoC information, and it is preferable that this information can be fetched out at any time. One example of the QFD-II using a similar QFD chart as that of the QFD-I is shown in FIGS. 27A to 27C.

Moreover, by using QFD data 6 prepared by the above-described QFD work, at the time of carrying out so-called concept selection (evaluation and selection of alternatives), cost evaluation and EMEA (Failure Mode and Effects Analysis) as well, it is effective that the VoC data 7 can be referred to.

As described above, in accordance with the present invention, a method and a program for supporting so that the QFD operator can carry out the QFD work appropriately and easily, can be provided.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can also be implemented as a computer readable recording medium in which a program for allowing a computer to execute predetermined means, allowing the computer to function as predetermined means, or allowing the computer to realize a predetermined function is recorded.

What is claimed is:

1. A method of supporting creation of a quality function development chart that converts customer requirements to product characteristics, comprising:
urging input of the customer requirements;
urging input of product characteristics associated with the customer requirements;
urging input of a degree of association between the customer requirements and the product characteristics;
urging input of a satisfaction degree of the customer requirements;
urging input of a comparison value to be compared with the satisfaction degree of the customer requirements; and
urging input of a target quality that is a goal of the customer requirements.

2. The method according to claim 1, further comprising:
urging input of a benchmark value of the product characteristics; and
urging input of a design quality for each of the product characteristics.

3. The method according to claim 1, further comprising:
sensing information inputted into the quality function development chart; and
displaying a field of the quality function development chart at which input should be carried out along with predetermined guidance information, based on a result of sensing.

4. The method according to claim 1, further comprising:
referring to voice of customer information when the customer requirements is input; and
associating the voice of customer information with the customer requirements.

5. The method according to claim 1, further comprising:
displaying a graph indicating a relationship between the satisfaction degree and the comparison value when the input of the design quality is urged.

6. The method according to claim 5, wherein a plurality of comparison values are input and a graph indicating a relationship between the satisfaction degree and a largest comparison value is displayed when the input of the design quality is urged.

7. The method according to claim 1, further comprising:
displaying a mark expressing that one customer requirements and one product characteristics should be associated in the quality function development chart when the degree of association between the customer requirements and the product characteristics is urged.

8. The method according to claim 1, further comprising:
urging input of a direction of improvement for the product characteristics; and
urging resetting of an opposite direction of improvement when it is detected that the opposite direction of improvement is set for the product characteristics associated with a plurality of customer requirements.

9. The method according to claim 1, further comprising:
determining whether or not an association between the customer requirements and the product characteristics correspond to a predetermined rule; and
urging re-association between the customer requirements and the product characteristics when the association is against the rule.

10. The method according to claim 1, further comprising:
calculating a first importance rating of the product characteristics in accordance with an independent weighting method, from a degree of association between the customer requirements and the product characteristics;
calculating a second importance rating of the product characteristics in accordance with a proportional weighting method, from the degree of association between the customer requirements and the product characteristics; and
calculating a guideline based on the first importance rating and the second importance rating.

11. The method according to claim 1, further comprising:
urging input of a benchmark value with respect to the product characteristics;
determining whether or not an association between the customer requirements and the product characteristics is appropriate, based on the inputted satisfaction degree of the customer requirements and the inputted benchmark value of the product characteristics; and
displaying an inappropriate combination of the customer requirements and the product characteristics when it is determined that the association is not appropriate.

12. The method according to claim 11, wherein it is determined that the association between the customer requirements and the product characteristics is not appropriate when a trend of the inputted satisfaction degree of the customer requirements is inconsistent with a trend of the inputted benchmark value of a corresponding product characteristics.

13. The method according to claim 2, further comprising:
urging input of a benchmark value with respect to the product characteristics;
determining whether or not an association between the design quality and the target quality is appropriate, based on the inputted satisfaction degree of the customer requirements and the inputted benchmark value of the product characteristics; and
displaying an inappropriate combination of the customer requirements and the product characteristics when it is determined that the association is not appropriate.

14. The method according to claim 13, wherein it is determined that the association between the design quality and the target quality is appropriate when a relationship between the inputted satisfaction degree of the customer requirements and the target quality is inconsistent with a relationship between the inputted benchmark value and the design quality.

15. The method according to claim 2, further comprising:
urging input of a benchmark value with respect to the product characteristics; and
displaying a guideline for the design quality based on the inputted satisfaction degree of the customer requirements and the inputted benchmark value.

16. An article of manufacture comprising a computer usable medium having computer readable program code means of supporting creation of a quality function development chart which converts customer requirements to product characteristics embodied therein, the computer readable program code means comprising:
computer readable program code means for causing a computer to urge input of the customer requirements;
computer readable program code means for causing a computer to urge input of product characteristics associated with the customer requirements;
computer readable program code means for causing a computer to urge input of a degree of association between the customer requirements and the product characteristics;
computer readable program code means for causing a computer to urge input of a satisfaction degree of the customer requirements;
computer readable program code means for causing a computer to urge input of a comparison value to be compared with the satisfaction degree of the customer requirements; and
computer readable program code means for causing a computer to urge input of a target quality that is a goal of the customer requirements.

17. The article of manufacture according to claim 16, further comprising:
computer readable program code means for causing a computer to urge input of a benchmark value of the product characteristics; and
computer readable program code means for causing a computer to urge input of a design quality for each of the product characteristics.

18. The article of manufacture according to claim 16, further comprising:
computer readable program code means for causing a computer to display a graph indicating a relationship between the satisfaction degree and the comparison value when the input of the design quality is urged.

19. The article of manufacture according to claim 18, wherein a plurality of comparison values are input and a graph indicating a relationship between the satisfaction degree and a largest comparison value is displayed when the input of the design quality is urged.

20. The article of manufacture according to claim 16, further comprising:
computer readable program code means for causing a computer to display a mark expressing that one customer requirements and one product characteristics should be associated in the quality function development chart when the degree of association between the customer requirements and the product characteristics is urged.

21. The article of manufacture according to claim 16, further comprising:
computer readable program code means for causing a computer to urge input of a direction of improvement for the product characteristics; and
computer readable program code means for causing a computer to urge resetting of an opposite direction of improvement when it is detected that the opposite direction of improvement is set for the product characteristics associated with a plurality of customer requirements.

22. The article of manufacture according to claim 16, further comprising:
computer readable program code means for causing a computer to determine whether or not an association between the customer requirements and the product characteristics correspond to a predetermined rule; and
computer readable program code means for causing a computer to urge re-association between the customer requirements and the product characteristics when the association is against the rule.

23. The article of manufacture according to claim 16, further comprising:
computer readable program code means for causing a computer to calculate a first importance rating of the product characteristics in accordance with an independent weighting method, from a degree of association between the customer requirements and the product characteristics;
computer readable program code means for causing a computer to calculate a second importance rating of the product characteristics in accordance with a proportional weighting method, from the degree of association between the customer requirements and the product characteristics; and
computer readable program code means for causing a computer to calculate a guideline based on the first importance rating and the second importance rating.

24. The article of manufacture according to claim 16, further comprising:
computer readable program code means for causing a computer to urge input of a benchmark value with respect to the product characteristics;
computer readable program code means for causing a computer to determine whether or not an association between the customer requirements and the product characteristics is appropriate, based on the inputted satisfaction degree of the customer requirements and the inputted benchmark value of the product characteristics; and
computer readable program code means for causing a computer to display an inappropriate combination of the customer requirements and the product characteristics when it is determined that the association is not appropriate.

25. The article of manufacture according to claim 17, further comprising:
computer readable program code means for causing a computer to urge input of a benchmark value with respect to the product characteristics;
computer readable program code means for causing a computer to determine whether or not an association between the design quality and the target quality is appropriate, based on the inputted satisfaction degree of the customer requirements and the inputted benchmark value of the product characteristics; and
computer readable program code means for causing a computer to display an inappropriate combination of the customer requirements and the product characteristics when it is determined that the association is not appropriate.

26. The article of manufacture according to claim 17, further comprising:
computer readable program code means for causing a computer to urge input of a benchmark value with respect to the product characteristics; and
computer readable program code means for causing a computer to display a guideline for the design quality based on the inputted satisfaction degree of the customer requirements and the inputted benchmark value.
